(19) United States
(12) Patent Application Publication
(10) Pub. No.: US 2009/0125882 A1
(43) Pub. Date: May 14, 2009

(54) METHOD OF IMPLEMENTING HYPEROBJECTS IN A PARALLEL PROCESSING SOFTWARE PROGRAMMING ENVIRONMENT

(76) Inventors: Matteo Frigo, Lexington, MA (US); Charles E. Leiserson, Cambridge, MA (US); Stephen T. Lewin-Berlin, Acton, MA (US)

Correspondence Address: STRATEGIC PATENTS P.C.., C/O PORTFOLIOIP, P.O. BOX 52050, MINNEAPOLIS, MN, 55402, US

(21) Appl. No.: 12/247,420

(22) Filed: Oct. 8, 2008

Related U.S. Application Data
(60) Provisional application No. 60/978,250, filed on Oct. 8, 2007.
(60) Provisional application No. 61/079,855, filed on Jul. 11, 2008.

(51) Int. Cl. G06F 9/44; G06F 9/45

(52) U.S. Cl. 717/116; 717/149

(57) ABSTRACT

In embodiments of the present invention improved capabilities are described for a runtime system for a multiple processing computing system, where multiple processing strands are implemented with hyperobjects. The hyperobject may be a reducer, a splitter, and the like, where the hyperobject may be considered a linguistic object that enables the operation of a plurality of views in the multiple processing environment. The runtime system may implement the hyperobject by managing operations on views, including one or more of creation, accessing, modifying, transferring, forking, combining, and destruction. Access of the views may happen independently from the linguistic control constructs of the code operating on the runtime system and may maintain the identity of the object so that any updating of the object results in updating of a view.

### CROSS-REFERENCE TO RELATED APPLICATIONS

This application claims the benefit of the following provisional applications, each of which is hereby incorporated by reference in its entirety:

U.S. Provisional App. No. 60/978,250 filed Oct. 8, 2007; and U.S. Provisional App. No. 61/079,855 filed Jul. 11, 2008.

### BACKGROUND

1. Field

The present invention is related to software programming, and more specifically relating to parallel processing capabilities within a software program.

2. Description of the Related Art

Many serial programs (those written for a single processor computer) use nonlocal variables, which are variables that are bound outside of the scope of the function, method, or class in which they are used. A variable bound outside of all local scopes is a global variable. Nonlocal variables have long been considered a problematic programming practice, but programmers often find them convenient to use, because they can be accessed at the leaves of a computation without the overhead and complexity of passing them as parameters through all the internal nodes. Thus, nonlocal variables have persisted in serial programming.

In the modern world of parallel computing, nonlocal variables may inhibit otherwise independent strands of a program from operating in parallel, because they introduce “data races.” A strand is a serial chain of instructions without any parallel control, typically executed by a thread, as in the POSIX threads or Windows API threads environments; by a process, as in the Linux or Windows operating systems; by a processor, as in the x86 or PowerPC computer architectures; or the like. A data race exists if logically parallel strands access the same shared memory location, the two strands hold no locks in common, and at least one of the strands writes to the location. A data race is usually a bug, because the program may exhibit unexpected, nondeterministic behavior depending on how the strands are scheduled. Serial code containing nonlocal variables may be particularly prone to the introduction of data races when the code is parallelized.

The present invention provides an improved method for constructing a program with parallel processing strands, while minimizing the issues associated with data races.

### SUMMARY

The present invention may provide a runtime system for a multiple processing computing system including multiple strands. The runtime system may contain a hyperobject facility that maintains a dynamic set of views of a linguistic object, called a hyperobject, that enables the operation of a plurality of views in the multiple processing environment. The hyperobject facility implements the hyperobject by managing operations on the views, including one or more of creation, accessing, modifying, transferring, forking, combining, and destruction. The hyperobject may be a reducer, a splitter, and the like. Access to the hyperobject may happen independently from the linguistic control constructs of the code operating on the runtime system and may maintain the identity of the hyperobject so that any updating of the hyperobject results in an updating of a view.

In embodiments, the hyperobject may enable computing code to operate in a multiple processing environment using the same linguistic specification for accessing the hyperobject as would be used for accessing a nonlocal variable in a serial processing environment, for accessing a nonlocal variable in a serial processing environment with an additional level of indirection, and the like.

In embodiments, the present invention may define a hyperobject that acts like an object that forks and combines, thereby facilitating parallel accumulation. In addition, the runtime system may incorporate a work-stealing scheduler. The hyperobject facility may operate by annotating a variable or object in the code to be a hyperobject, a hyperpointer, and the like. The annotation may indicate that the hyperobject can be at least one of reduced and split.

In embodiments, the present invention may also provide a debugging tool that reports races in computer code in a multiple processing environment containing a hyperobject facility, include a performance analysis tool that reports a measure on the execution of computer code in a multiple processing environment, and the like, where the measure may include work, span, parallelism, spawns, syncs, calls, parallel granularity, serial granularity, lock contention, false sharing, and the like. These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a runtime system's data structures from the point of view of a worker.

FIG. 2 depicts a global view of an embodiment of the runtime system's data structures.

FIG. 3 depicts an embodiment of how hyperobjects are implemented.

FIG. 4 depicts a bag data structure, where a bag with 23 elements is illustrated.

While the invention has been described in connection with certain preferred embodiments, other embodiments would be understood by one of ordinary skill in the art and are encompassed herein.

All documents referenced herein are hereby incorporated by reference.

### DETAILED DESCRIPTION

The present invention may provide improved facilities for implementing parallel processing stands within a software program, such as a C++ program. In the following disclosure, the programming language C++ will be used as an example of how the present invention may extend a software language to include features and functions of the present invention. However, it is understood that this is not limiting to the C++ language, and that the present invention may similarly be implemented with other programming languages. Further, for convenience in description, the present invention, and components thereof, may be referred to or referenced with regard to the term Cilk or Cilk++. Embodiment programming examples are disclosed herein, as the present invention's extensions to a language, such as to the C++ language, may be better understood from examples. For example, Code Block 1 shows a Cilk++ program that implements a C++ quicksort algorithm. In this instance, it will be observed that the program would be an ordinary C++ program if the two keywords ‘cilk_spawn’, and ‘cilk_sync’ were elided and the keyword ‘cilk_for’ were replaced by ‘for’.

Code Block 1, parallel quicksort implemented in Cilk++:

| 1 | // Parallel quicksort |
|---|---|
| 2 | using namespace std; |
| 3 | |
| 4 | #include <algorithm> |
| 5 | #include <iterator> |
| 6 | #include <functional> |
| 7 | |
| 8 | template <typename T> |
| 9 | void qsort(T begin, T end) { |
| 10 | if (begin != end) { |
| 11 | T middle = partition( |
| 12 | begin, |
| 13 | end, |
| 14 | bind2nd( less<typename |
| iterator_traits<T>::value_type>( ), | |
| 15 | *begin ) |
| 16 | ); |
| 17 | cilk_spawn qsort(begin, middle); |
| 18 | qsort(max(begin + 1, middle), end); |
| 19 | cilk_sync; |
| 20 | } |
| 21 | } |
| 22 | |
| 23 | // Simple test code: |
| 24 | #include <iostream> |
| 25 | #include <cmath> |
| 26 | |
| 27 | int main( ) { |
| 28 | int n = 100; |
| 29 | double a[n]; |
| 30 | |
| 31 | cilk_for (int i=0; i<n; ++i) { |
| 32 | a[i] = sin((double) i); |
| 33 | } |
| 34 | |
| 35 | qsort (a, a + n); |
| 36 | copy (a, a + n, ostream_iterator<double>(cout, “\n”)); |
| 37 | |
| 38 | return 0; |
| 39 | } |

In embodiments, parallel work may be ‘spawned’ when the keyword cilk_spawn precedes the linguistic control construct indicating invocation of a function. Spawning may call the function while simultaneously allowing the parent to continue to execute in parallel with the child, instead of waiting for the child to complete as with a normal function call. In one embodiment, a cilk_spawn statement may have a form, such as:

```
    receiver assignment_operator ’cilk_spawn’ postfix_expression ’(’
expression_list ’)’ ’;’
or
    ’cilk_spawn’ postfix_expression ’(’ expression_list ’)’ ’;’
```

where ‘receiver’ is an lvalue logical_or_expression. In embodiments, Cilk++ and C++ functions may interoperate seamlessly, in that a Cilk function may be either called or spawned. The Cilk++ runtime system may schedule the spawned functions on the individual processors of a shared-memory multiprocessor, processing cores of a multicore processor, other computing system with multiple processors, and the like.

The cilk_sync statement may allow a function to ‘sync’ with its children. The cilk_sync statement may be a local “barrier” that may suspend execution of the function until its spawned children return. In the quicksort example of Code Block 1, the cilk_sync statement on line 19 may help ensure that the children run to completion before the function qsort returns, thereby potentially avoiding the anomaly that would occur if the recursive calls to qsort were scheduled to run in parallel and did not complete before the return, thus leaving the vector to be sorted in an intermediate and inconsistent state.

In addition to explicit synchronization provided by the cilk_sync statement, a function that spawns may sync implicitly before it returns, thus ensuring that its children terminate before it does. Thus, for this example, the explicit cilk_sync before the function returns may be unnecessary.

In embodiments, the semantics of calling, spawning, and synching may be summarized as follows. First there is a call, where the parent may wait for the child to complete, and the return value may be available after the call. Then a spawn, where the parent function may be allowed to run in parallel with the child, and the return value may be available after the next sync. And finally a sync, where the program waits for all outstanding spawned children of the current function to return. Loops may be parallelized by simply replacing the C++ keyword ‘for’ with the Cilk++ keyword cilk_for, which allows all iterations of the loop to operate in parallel. Exemplary code for an embodiment of a parallel quicksort implemented in Cilk++ is provided as an example as shown in Code Block 1. Within the main routine, for example, the loop control construct starting on line 31 of Code Block 1 may fill the array in parallel with random-looking numbers.

In embodiments, the Cilk++ environment may provide full support for program exceptions, such as C++ exceptions. For instance, when a C++ function throws an exception, it may cause a nonlocal transfer of control to the catch clause of the nearest dynamically enclosing try statement whose catch clause handles the exception. If more than one exception is thrown concurrently, the Cilk++ runtime system may process one exception and discard the others. This process may cause any functions, expressions, etc., that have begun but not completed to be abruptly terminated until an appropriate handler is found. Cilk++ may preserve these semantics and extend them by additionally aborting any side computations that have been spawned off or allowing them to terminate normally. This implicit abort mechanism may provide one way for Cilk++ to support speculative parallelism.

Other ways for supporting speculative parallelism may include a cilk_break statement within a parallel loop. The cilk_break may act like an ordinary break statement in a serial loop, in that it may cause the loop to terminate and suppresses the execution of any loop iterations that have not yet been started. Cilk++ may extend these semantics by either aborting any other loop iterations that have been started or allowing them to terminate normally before completing the loop. Cilk++ may include a library for mutual-exclusion (mutex) locks. In addition or as an alternative, Cilk++ may support transactional memory and other lock-free mechanisms to enforce atomicity.

The Cilk++ compiler may implement the Cilk++ language by translating Cilk++ into executable code with calls to the Cilk++ runtime system as described herein. In general, a runtime system may be the set of software that provides services for a running program. One may say that the running program runs or operates on the runtime system. Examples may include the code that manages the runtime stack, whether handwritten or compiler generated; the code that implements function call and return conventions, whether hand-written or compiler generated; the code in the operating system or generated by the compiler to manage exceptions; library code for handling memory management (for example, mallac or new); code that handles dynamic loading and linking; debugger code that is generated at compile time or run time; thread-management code, and the like. In embodiments, a runtime system may be provided by the operating system, as a separately linked library, as code generated by the compiler, and the like. Byte-code interpreters and virtual machines may also be considered runtime systems. The Cilk++ runtime system may provide an important component of the environment in which Cilk++ programs execute.

A Cilk++ (or other parallel) execution may be viewed as a collection of strands, each of which may be a serial list of ordinary, nonsynchronizing instructions executed one after another. Synchronizing events, such as spawning, returning from a spawn, synching, forking, joining, message sending, message receiving, lock acquisition, lock release, and the like, may create dependencies between strands. If a strand A must execute before a strand B can execute, for example, because A is the code executed before a spawn and B is code executed after, then a series precedence relationship may exist between A and B, where A precedes B. The precedence relationship may be transitive, meaning that if A precedes B and B precedes C, then A precedes C. Two strands A and B may be parallel, denoted A∥B if no series relationship exists between A and B, that is, A does not precede B and B does not precede A.

The Cilk++ runtime system may be organized around a plurality of data structures, such as workers, stack frames, full frames, and the like. A worker may abstract the notion of a processor executing the Cilk scheduler. A worker may be an OS-level thread (such as a POSIX thread or Windows API thread) sharing the address space with other workers in the same Cilk job. The Cilk++ runtime system may maintain a set of P workers, where P is the maximum concurrency allowed by the system. A stack frame may be allocated when the execution calls or spawns a function and provides storage for the variables declared in that function. In embodiments, in a block-structured language, entering or spawning a block could also cause stack-frame allocation. In addition, each frame may maintain certain information, such as a lock; a continuation, which contains enough information to resume the frame after a suspension point; a join counter, which counts how many child frames are outstanding; a pointer to the parent frame; a list of outstanding children; subroutine linkage information for returning values from a function call; data structures needed for exception processing; and the like. As an optimization, frames may store this information implicitly. The frames that store information explicitly may be called full frames, and the rest may be called stack frames. An embodiment that distinguishes between the two types is described herein; but for purposes of the current discussion, the distinction between the two kinds may be largely ignored.

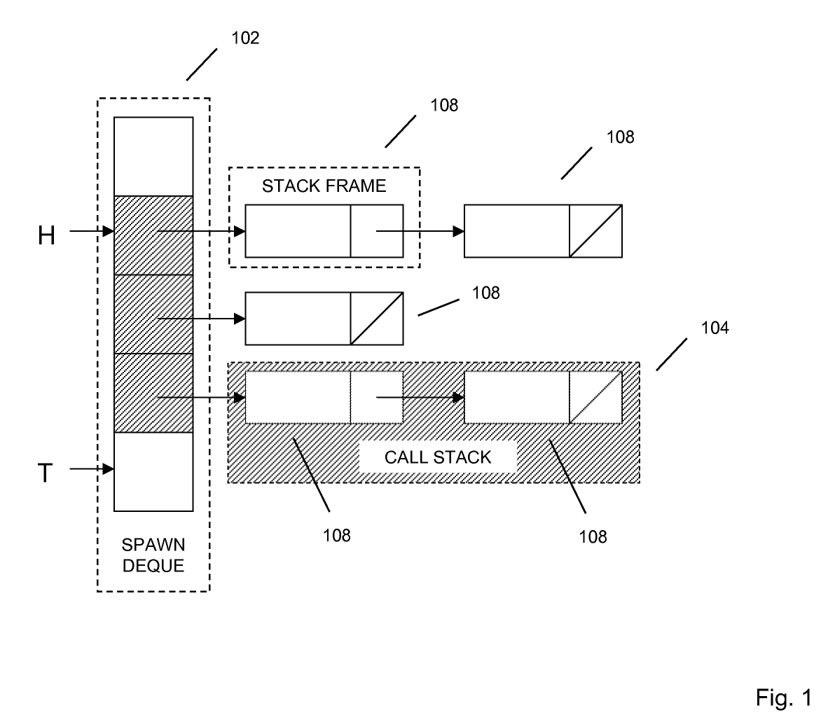

FIG. 1 illustrates the runtime system data structures from the point of view of a worker. The worker owns a spawn deque 102 of call stacks 104, where each call stack may be implemented as a (singly) linked list of stack frames 108. A stack frame 108 may point to its dynamic parent function, i.e., the function that called the child function. In addition, each worker may maintain a current call stack 104, which may be a call stack under construction that has not been pushed onto the deque 102, as well as other ancillary structures such as locks and free lists for memory allocation. In embodiments, the deque 102 may be implemented as an array of pointers, where array position Xmay contain a valid pointer for H≦X≦T.

Frames 108 belonging to a deque 102 may admit a simplified storage scheme. Except for the oldest frame in the deque, a frame may have no outstanding children if it is the youngest frame in the deque, and exactly one outstanding child otherwise. Thus, for these frames, one may not need to store a join counter or a list of children. Similarly, with the exception of the oldest frame in the deque, the parent of a frame in a deque may be either the next frame in the call stack, if such a frame exists, or else the first frame in the previous deque entry.

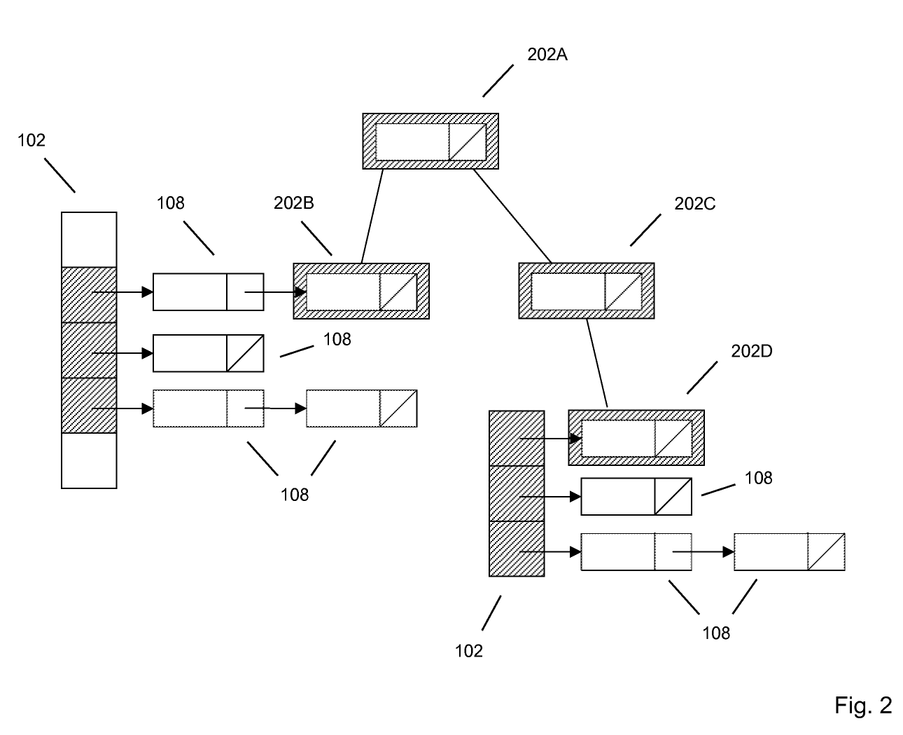

The Cilk++ runtime system may only need to store explicit parent/child pointers for frames that either are in no deque (because they are suspended at a cilk_sync) or are the oldest frames in some deque. In this case, it may be said that the frame has been promoted to a full frame 202. All other frames may be stack frames 108. An embodiment of the runtime-system data structures, illustrating deques 102, stack frames 108, full frames 202, and the like, is shown in FIG. 2, providing a global view of an embodiment of the Cilk++ runtime system data structures. White rectangles represent stack frames 108, and a hashed border denotes that the stack frame has been promoted to a full frame 202. Frames 202A and 202C belong to no deque, and consequently they are full. In particular, 202C may store an explicit pointer to its parent A and subroutine linkage information for returning values to 202A. Frames 202B and 202D may be full frames because they are the oldest frames in their respective deques. Their children may be stored implicitly in the deque, but these frames may maintain an explicit pointer to their respective parents 202A and 202C.

The Cilk++ runtime system may execute certain actions at distinguished points of the client program, such as when calling and spawning functions, when synching, when returning from a function, and the like. In addition, in certain cases, the runtime system may obtain work, such as by a random steal, a provably good steal, and the like, as described herein. The actions of the runtime system will now be described in all these cases for one embodiment of the invention. These actions are all intended to be executed as if they were atomic. In one embodiment, a lock stored with the worker data structure may be used to enforce atomicity. In another embodiment, separate locks may be stored in the frames. In yet another embodiment, atomicity may be maintained using nonblocking protocols. Any of these embodiments involves ways of enforcing atomicity that would be generally understood by a person of ordinary skill in the art.

A Cilk++ runtime system operator may include a function call. To call a function B from a function A, all function arguments to B may be evaluated into temporary variables stored in either A's frame or temporary storage dedicated to parameter passing (e.g., registers). The runtime system may set the continuation of the current function A so that execution of A may resume immediately after the call. The runtime system may then allocate a frame for B. The runtime system may then push B onto the current call stack as a child of A. Control of user code may now resume with the execution of B.

A Cilk++ runtime system operator may include a spawn. To spawn a function B from a function A, all function arguments to B may be evaluated into temporary variables stored in either A's frame or temporary storage dedicated to parameter passing (e.g., registers). The runtime system may set the continuation of the current function A so that execution of A may resume immediately after the cilk_spawn statement. The runtime system may then allocate a frame for B. The runtime system may then push A onto the bottom of the worker's deque and start a new call stack containing B. Control of user code may now resume with the execution of B.

A Cilk++ runtime system operator may include a return from a call. The action of the runtime system on a return from a call may depend on whether or not the frame associated with the function is a stack frame or a full frame. If the frame is a stack frame, the runtime system may pop the frame from the current call stack and deallocate it. Execution may continue from the continuation of the parent. If the frame is full, the runtime system may pop the frame from the current call stack. The current call stack may now be empty. The runtime system may now deallocate the full frame, decrement the join counter of the parent frame, resume execution of the parent from its continuation, and the like.

A Cilk++ runtime system operator may include a return from a spawn. As with calls, the action of the runtime system on a return from a spawn may depend on whether or not the frame associated with the function is a stack frame or a full frame. If the frame is a stack frame, the runtime system may pop the frame from the current call stack and deallocate it. The current call stack may now be empty. The worker may now pop a new current call stack from the bottom of its deque. If the pop operation fails because the deque is empty, the worker may begin random work stealing. If the pop operation does not fail, execution may continue from the continuation of the parent. If the frame is full, the runtime system may pop the frame from the current call stack. The current call stack may now be empty. The runtime system may now deallocate the full frame and execute a provably good steal of the parent frame.

A Cilk++ runtime system operator may include a Cilk synchronization, also referred to as sync. In this operator, if the frame A is a stack frame, then sync may be a no-op. Otherwise, the runtime system may execute an action, such as increment the join counter of A, provably-good-steal frame A, and the like. In embodiments, the increment of the join counter of A may be merged with the decrement of the join counter affected by the provably good steal.

A Cilk++ runtime system operator may include a ‘provably good steal’, which may be an operation that checks whether the conditions for passing a cilk_sync statement are satisfied, and if so it may resume the frame after the cilk_sync. To provably-good-steal frame A, a thief worker may perform an action, such as to decrement the join counter of A, resume the execution of A if the join counter is 0 and no worker is working on A, and the like.

A Cilk++ runtime system operator may include a ‘random work steal’. When a worker w becomes idle, it may become a thief and may steal work from a victim worker chosen at random, such as by picking a random victim v, where v≠w, repeating this step while the deque of v is empty; removing the oldest call stack from the deque of v, and promote all frames in the call stack to full frames, letting booty be the youngest frame in this call stack; promoting the oldest frame now in v's deque to a full frame and make it a child of booty; resuming execution of booty; and the like.

In embodiments, the present invention may provide for exception processing. Some programming languages, such as Cilk++, may support exceptions, a linguistic control construct and runtime mechanism that allow a function to return to a continuation different than its ordinary continuation. Such an exceptional continuation may be used, such as for handling errors or cleaning up the program state after an error has occurred. Cilk++ may use the runtime mechanisms described herein to support exceptions as well as ordinary returns. An example of exceptions may include when the execution resumes from a continuation, it may be an exceptional continuation, and the like. If, by effect of multiple exceptions being thrown concurrently, the exceptional continuation becomes ambiguous, then Cilk++ may select which continuation to resume from, discarding the other continuations and the associated exceptions.

In embodiments, the present invention may provide for parallel loops, a mechanism that may divide the execution of loops to run on one or more processors. The syntax for expressing parallel loops may minimize the source code changes used to identify a parallel loop in existing source code. In addition, parallel loops may be expressed in terms of existing types and may not require the programmer to define new data types or new methods of existing data types in order to support parallel operation. In embodiments, a control construct for parallel loops may be specified linguistically, such as and how parallel loops may be converted into code that expresses the same iterative structure using partial recursion. The resulting transformed code may be well suited for execution in a work-stealing environment. The control construct for parallel loops may be designated in a particular way, such as for example:

cilk_for (initializer ; terminator ; repeater )
{
/* LOOP-BODY */
}

In embodiments, description of syntax terms may include an initializer, terminator, repeater, and loop-body terms as described herein, and the like. The initializer may be a declaration, such as of the form T V=INIT, where T is the type of the control variable, V is the control variable used to control the loop, and INIT is the initial value of V, and where INIT may be an expression that evaluates to a value of type T. The type T may an integral type (e.g., Let T::difference_type=T), a pointer type (e.g., T::difference_type=ptrdiff_t), a random-access iterator such that T::difference_type is an arithmetic type, and the like. The terminator may define the termination condition of the loop. The terminator may have a form, such as v<expression, V<=expression, V !=expression, V>expression, V>=expression, expression>V, expression>=V, expression !=V, expression<V, expression<=V, and the like. The terminator may be evaluated a different number of times during the execution of a parallel loop than the number of times it is evaluated during an ordinary C++ serial execution. The repeater may be an expression option that defines the iteration condition of the loop. A repeater may have a form, such as V++, ++V, V−−, −−V, V+=constant, V−=constant, and the like, where ‘constant’ may be a loop-independent constant. The operator used, such as ‘++’, ‘−−’, and the like, may be defined for the type T used in the parallel loop. Other repeaters may also be possible.

In embodiments, a loop body may be program code that is executed zero or more times, depending on the values of the initializer, terminator, repeater, and the like. Separate iterations of the loop body may be, but are not required to be, executed in parallel. Within the loop body, the control constructs break, return, and goto LABEL, where LABEL is outside the scope of the loop body, may take on meanings that represent an extension of their serial meanings. Each may cause the loop to terminate, and other parallel iterations that are currently executing may be also terminated, either by waiting until they are done, or by aborting them, depending on desired semantics. The constructs may differ on where control resumes after loop termination, such as with ‘break’, where control resumes at the statement after the loop; return, where control resumes at the statement with label ‘label’; and the like. In embodiments, it may be advantageous to use special keywords, such as cilk_break, so that the programmer declares awareness that the loop being broken out of is a parallel loop. The following is an example syntax for a parallel loop construct:

```
// parallel loop expressed using variable ’V’ of type ’int’
cilk_for ( int V = INIT; V < MAX; V++)
{
    /* LOOP BODY */
}
//expressed using variable ’V’ of type ’vector::iterator’
and
//object ’v’ of type ’vector’
cilk_for (vector::iterator V = v.begin( ); V != v.end( );
++V)
{
    /* LOOP BODY */
}
```

The general type case is shown here (using the repeater V++):

// expressed generally using variable ’V’ of type ’T’
cilk_for ( T V = INIT; V < MAX; V++)
{
/* LOOP BODY */
}

In embodiments, two or more loops may be nested. In this case, it may be possible to allow stealing of both loops, for example, by alternating which loop is stolen from. In addition, it may be desirable via a pragma or other linguistic construct to specify the sizes of base cases. In embodiments, loops may also involve multiple index variables.

Parallel loops may be implemented by transforming the loop (as expressed in the syntax described herein) into a form that may be executed by the target computer or into a form that may be compiled by another compiler. In the following, a rule, referred to as recursive transformation, is described that may transform a parallel loop expressed with the cilk_for keyword into Cilk++ using the cilk_spawn and cilk_sync keywords. Another rule, referred to as loop stealing, is also described that may transform a parallel loop more directly into executable parallel code. The strategy employed for recursive transformation may be to create a recursive dummy function that expresses the equivalent loop using recursion to expose opportunities for parallel operation. Other transformations may be possible, including using a tail-recursive dummy function. Exemplary code for an embodiment of a transformation of a simple parallel loop construct is provided as an example as shown in Code Block 2. This may be considered a “simple” loop, because it uses the ‘int’ type for the control variable and no free variables are carried into the dummy function. Exemplary code for an embodiment of a more general case with free variables and an arbitrary type for the control variable is provided as an example as shown in Code Block 3.

Code Block 2, transformation of a simple parallel loop:

```
// Simple parallel loop as expressed by the user
void ParentFunction(...)
{
    .
    .
    .
    cilk_for ( int V = INIT; V < MAX; V++)
    {
        /* LOOP_BODY */
    }
    .
    .
    .
}
// Simple loop transformed to use recursion and spawning.
void DUMMY (int V, int H)
{
  int d;
    if ((d = (H − V)) > CUTOFF)
    {
        int M = V + (d / 2) ;
        cilk_spawn DUMMY(V, M);
        DUMMY(M, H);
        cilk_sync;
    }
    else
    {
        for ( ; V < H; V++)
        {
            /* LOOP BODY */
        }
    }
}
void ParentFunction(...)
{
    .
    .
    .
    DUMMY(INIT, MAX);
    .
    .
    .
}
```

Code Block 3, a more general case with nonlocal variables and an arbitrary type for the control variable:

| | |
|---|---|
| 1 | // General parallel loop as expressed by the user |
| 2 | |
| 3 | void ParentFunction(...) |
| 4 | { |
| 5 | . |
| | . |
| | . |
| 6 | T1 V1; // declare variable V1 of type T1 |
| 7 | T2 V2; // declare variable V2 of type T2 |
| 8 | . // additional declarations |
| | . |
| | . |
| 9 | use(V1);// make use of variable V1 |
| 10 | use(V2);// make use of variable V2 |
| 11 | |
| 12 | cilk_for ( T V = INIT; V < MAX; V++) |
| 13 | { |
| 14 | /* LOOP BODY */ |
| 15 | } |
| 16 | . |
| | . |
| | . |
| 17 | } |
| 18 | |
| 19 | // The same loop transformed to use recursion and spawning. |
| 20 | |
| 21 | void DUMMY(T V, T H, T1 &V1, T2 &V2) |
| 22 | { |
| 23 | T::difference_type d; |
| 24 | |
| 25 | if ((d = (H − V)) > CUTOFF) |
| 26 | { |
| 27 | T M = V + (d / 2); |
| 28 | cilk_spawn DUMMY(V, M, V1, V2, ...); |
| 29 | DUMMY(M, H, V1, V2, ...); |
| 30 | cilk_sync; |
| 31 | } |
| 32 | else |
| 33 | { |
| 34 | for ( ; V < H; V++) |
| 35 | { |
| 36 | /* LOOP BODY * / |
| 37 | } |
| 38 | } |
| 39 } | |
| 40 | |
| 41 | void ParentFunction(...) |
| 42 | { |
| 43 | T1 V1; // declare variable V1 of type T1 |
| 44 | T2 V2; // declare variable V2 of type T2 |
| 45 | // additional declarations |
| 46 | use(V1);// make use of variable V1 |
| 47 | use(V2);// make use of variable V2 |
| 48 | |
| 49 | DUMMY(INIT, MAX, V1, V2); |
| 50 | } |

Notes on the general transformation:
Line 14: LOOP BODY represents the original body of the untransformed loop.
Line 23: difference_type is an arithmetic type.
Line 25: CUTOFF is defined to optimize the execution of the loop. An optimal value of CUTOFF may minimize the number of recursive calls, while exposing sufficient parallelism to use multiple processors when available. CUTOFF may be specified by the user via a pragma or configuration setting, determined statically by the compiler, determined dynamically by the program or runtime system, determined by instrumenting test runs of the program, and the like. If the number of remaining iterations is less than CUTOFF, the remaining iterations may be performed serially.
Line 27: The remaining iterations of the loop are divided at the midpoint, but other points within the space of iterations are possible. The lower portion of the loop (ranging from V to M) may be processed in a new context created by the recursive spawn to DUMMY. The upper portion of the loop (ranging from M to H) may be processed in a new context created by the recursive call to DUMMY. Alternatively, the iteration space may be divided into more than two regions which may be spawned separately. Alternatively, the recursive call to DUMMY may be replaced by a tail-call.
Line 28: The spawn command may identify the recursive call to DUMMY as a call that allows the task to be stolen.
Line 29: The last recursive call to DUMMY may be spawned or just called.
Line 36: LOOP BODY is the original body of the untransformed loop. Each reference to a nonlocal variable (V1, V2, etc.) may refer to the reference to that variable that has been passed as an argument to the DUMMY function. Alternatively, instead of passing references to nonlocal variables as explicit arguments, all references may be aggregated into a closure and the closure may be passed as an argument to DUMMY.

In the serial processing of the lower portion of the loop, an additional optimization to maximize parallel execution may be available. If there is more than one iteration of the loop remaining, and the ‘worker->head’ is equal to the ‘worker->tail’, which may indicate that the current iteration of the loop was stolen, then maximal parallelism may be exposed by spawning at least one additional iteration of the loop. In embodiments, only those variables Vn that are referenced in the loop body may need to be passed into the DUMMY function. Note that if the repeater is of the form V−− or −−V, then the transformation may use V−H instead of H−V, and v−− may be used in place of V++ in the recursive transformation.

Another embodiment may implement parallel loops using a strategy called loop stealing. The idea of loop stealing may be to transform the loop body as little as possible. For instance, a worker A executes a loop serially, but when another worker B wishes to obtain work, it modifies the loop termination condition for A so that A will terminate the loop early, leaving B with the balance of loop iterations to steal and execute. For example, suppose that the loop index i runs from m to n and that A has executed iterations m, m+1, . . . , k, where k≦n. Each time through the loop, A compares the index i to the value n to see whether the loop should terminate. Worker B may steal some iterations by setting the termination index n to another value, such as (n−k)/2, and then execute iterations (n−k)/2+1, (n−k)/2+2, . . . , n itself. Other workers, including A and B if they finish their portions of the loop, may continue to loop-steal from these ranges as well.

Many serial programs use nonlocal variables, which are variables that are bound outside of the scope of the function, method, or class in which they are used. If a variable is bound outside of all local scopes, it is a global variable. Sometimes the operations on nonlocal variables require only updates according to an operator such as integer addition. In embodiments, the present invention may provide for “hyperobjects,” which may provide both local state and a way for specifying updates to nonlocal variables. The present invention may provide a runtime system for a multiple processing computing system including multiple strands, and associating with the runtime system a hyperobject facility that maintains a dynamic set of views. The hyperobject facility may manage operations on the views, including one or more of creation, accessing, modifying, transferring, forking, combining, and destruction. The hyperobject may be considered a linguistic object that enables the operation of a plurality of views in the multiple processing environment. Access of the views may happen independently from the linguistic control constructs of the code operating on the runtime system and may maintain the identity of the object so that any updating of the object results in updating of a view. The hyperobject may be a reducer, a splitter, and the like, as described herein.

In a programming language, the term object may refer to an allocated region of storage, not necessarily contiguous, containing a combination of data and the instructions that operate on the data. An object may be characterized by a number of properties, such as an identity, the property of an object that may distinguish it from other objects; a state, the data stored in the object; methods, the instructions that access and potentially modify the state; and the like. In embodiments, the state of an object may change during program execution as a result of executing the object's methods.

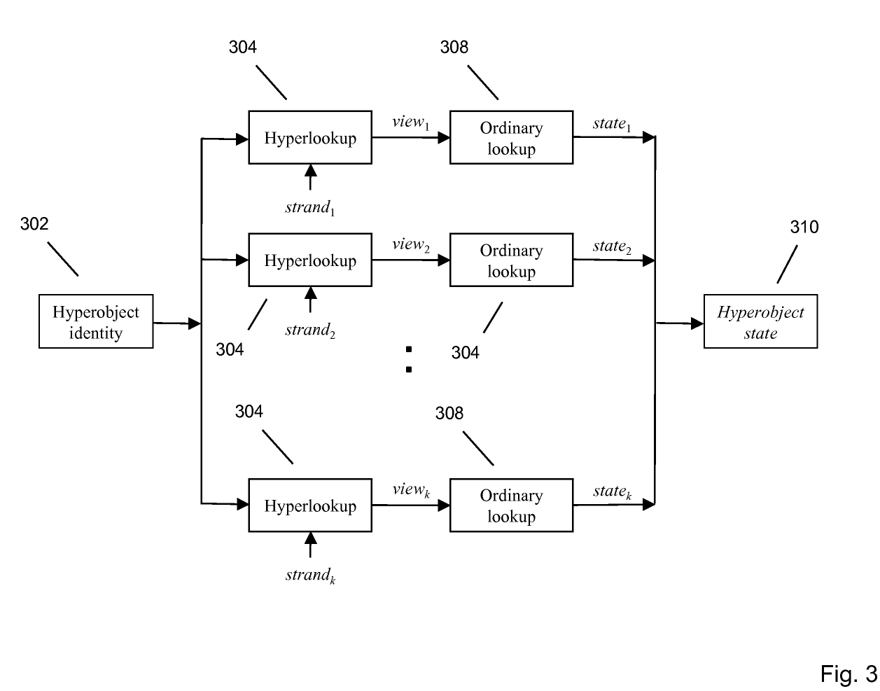

In a parallel program, a shared object may be one that is accessed simultaneously by different parallel strands of execution. A change to the object by one strand may become visible to other strands that share the object. Traditionally, memory-consistency hardware and various synchronization mechanisms, including locking for mutual exclusion, may be employed to ensure that all strands see the same sequence of state changes and that their respective views at given points in time, depending on the consistency model, are essentially identical. Hyperobjects may be considered to be a programming abstraction for parallel computing that extends the notion of a shared object by providing different views of the object to different strands of a parallel program. FIG. 3 provides an embodiment of how hyperobjects may be implemented within the semantic structure of the program. Here, the hyperobject identity 302 is associated with a plurality of strands, where each strand may perform a hyperlookup 304 on the hyperobject 302 to produce its own view of the hyperobject. Each strand may now perform an ordinary lookup 308 on its view to obtain its local state, which the strand may read and modify, wherein all states may contribute to the overall hyperobject state 310.

Many serial programs use nonlocal variables, which are variables that are bound outside of the scope of the function, method, or class in which they are used. If a variable is bound outside of all local scopes, it is a global variable. Nonlocal variables have long been considered a problematic programming practice, but programmers often find them convenient to use, because they can be accessed at the leaves of a computation without the overhead and complexity of passing them as parameters through all the internal nodes. Thus, nonlocal variables have persisted in serial programming.

In parallel computing, nonlocal variables may inhibit otherwise independent strands of a program from operating in parallel, because they may introduce “data races.” A data race exists if logically parallel strands access the same shared location, the two strands hold no locks in common, at least one of the strands writes to the location, and the like. A data race may be considered a bug, because the program may exhibit unexpected, nondeterministic behavior depending on how the strands are scheduled. Serial code containing nonlocal variables may be particularly prone to the introduction of data races when the code is parallelized.

As an example of how a nonlocal variable can introduce a data race, consider the following “collision-detection” problem in which a mechanical assembly is represented as a tree of subassemblies, where the leaves are individual parts. Given a target object, the serial collision-detection code, which is abstracted in Code Block 4, recursively visits all the subassemblies. Whenever it finds a leaf node, it checks whether the corresponding part intersects target, and if so, it appends the part to the list stored in the global variable output list. An embodiment of a parallelization of this code in Cilk++is shown in Code Block 5. Unfortunately, this naive parallelization contains a data race, because two parallel strands may attempt to update the shared global variable ‘output_list’ in parallel at line 10. A traditional solution to fixing this kind of data race may be to associate a mutual-exclusion lock with ‘output_list’. Before updating ‘output_list’, the lock is acquired, and after the update, it is released. The problem with this approach, however, is that the lock may become a bottleneck in the computation. If there are many parts that collide with the target, the contention on the lock can destroy all the parallelism. For example, lock contention may actually degrade performance on multiple processors to be worse than running on a single processor. An alternative to locking may be to restructure the code to accumulate the output lists in each subcomputation and concatenate them when the computations return. Unfortunately, restructuring of the logic may be time-consuming, tedious, and may require expert skill, which may make it impractical for parallelizing large legacy codes.

Code Block 4, C++ code that creates a list of all parts in an assembly that intersect a given target object:

```
Node *target;
std::list <Node *> output_list;
.
.
.
void walk (Node *x)
{
    switch (x->kind) {
    case Node::LEAF:
        if (target->collides_with(x))
        {
            output_list.push_back(x);
        }
        break;
    case Node::INTERNAL:
        for (Node::const_iterator child = x.begin( ); child !=
x.end( ); ++child)
        {
            walk(child);
        }
        break;
    }
}
```

Code Block 5, a naive Cilk++ parallelization of the code in Code Block 4. This code has a data race in line 10:

| 1 | Node *target; |
|---|---|
| 2 | std::list <Node *> output_list; |
| 3 | . |
| | . |
| | . |
| 4 | void walk(Node *x) |
| 5 | { |
| 6 | switch (x->kind) { |
| 7 | case Node::LEAF: |
| 8 | if (target->collides_with(x)) |
| 9 | { |
| 10 | output_list.push_back(x); |
| 11 | } |
| 12 | break; |
| 13 | case Node::INTERNAL: |
| 14 | cilk_for (Node::const_iterator child = x.begin( ); |
| child != x.end( ); ++child) | |
| 15 | { |
| 16 | walk(child); |
| 17 | } |
| 18 | break; |
| 19 | } |
| 20 | } |

The present invention may extend the serial semantics of a programming language (e.g., C++) using hyperobjects, a linguistic construct in a programming language that may allow many strands to coordinate in updating a shared variable or data structure independently by providing different views of the object to different strands at the same time, thereby avoiding data races in code with nonlocal variables. In embodiments, the present invention may enable computing code to operate in a multiple processing environment using the same linguistic specification for accessing the hyperobject as would be used for accessing a nonlocal variable or object in a serial processing environment, for accessing a nonlocal variable or object in a serial processing environment with an additional level of indirection, and the like. In embodiments, hyperobjects may allow the avoidance of problems endemic to locking, such as lock contention, deadlock, priority inversion, convoying, and the like. In embodiments, the present invention may provide a runtime system including multiple strands providing a hyperobject facility for enabling code containing a shared nonlocal variable to operate on the runtime system without races and providing a linguistic specification in the computer code for indicating updates to the variable. Further, the linguistic specification may allow updates to the variable to be indicated independently from the control constructs in the computer code. In embodiments, the control construct may be a serial or parallel loop. In embodiments, the present invention may provide a runtime system and associated hyperobject facility that may enable the parallel strands in a multiple processing environment to access a plurality of views of a hyperobject. Accesses to the views may happen independently from the linguistic control constructs of the code operating on the runtime system and may maintain the identity of the hyperobject so that any updating of the hyperobject results in an updating of a view. In embodiments, the present invention may provide a runtime system for a multiple processing computing system including multiple strands and providing a hyperobject facility for enabling code containing a shared nonlocal variable to operate on the runtime system without races. Further, a linguistic specification may allow updates to the variable to be indicated independently from any data structure from which the values provided for the updates may be taken. In embodiments, the data structure may be an array, a vector, a matrix, and the like. In embodiments, the present invention may provide a runtime system for a multiple processing computing system including multiple strands enabling code containing a shared nonlocal variable to operate on the runtime system without races. A linguistic specification may be provided in the computer code for indicating updates to the nonlocal variable, where the linguistic specification allows updates to the nonlocal variable to be indicated without specifying locks or other linguistic constructs for atomicity or mutual exclusion.

A hyperobject as seen by a given strand of an execution may be referred to as the strand's view of the object at the time the strand is executing. A strand may access and change any of its view's state independently, without synchronizing with other strands. Throughout the execution of a strand, the strand's view of the hyperobject may be private, thereby providing isolation from other strands. When two or more strands join, their different views may be combined according to a system-defined or user-defined method, one or more of the views may be destroyed, one or more of the views may be transferred to another strand, and the like.

The identity of the hyperobject may remain the same from strand to strand, even though their views of the hyperobject may differ. Thus, any update to the hyperobject, whether free or bound in a linguistic construct, whether accessed as a named variable, as a global variable, as a field in an object, as an element of an array, as a reference, as a parameter, through a pointer, and the like, may update the strand's view. This transparency of reference, wherein an access of the hyperobject in a strand may access the strand's view, may happen independently from any specific control construct within the code operating on the runtime system wherever and whenever the hyperobject is accessed. Hyperobjects may simplify the parallelization of programs with nonlocal variables, such as the global variable illustrated in Code Block 6. In embodiments, hyperobjects may preserve the advantages of parallelism without forcing the programmer to restructure the logic of the program.

Code Block 6, a program that computes Fibonacci numbers by accumulating values in a global variable x:

```
int x;
void fib(int n)
{
    if (n < 2)
        x += n;
    else {
        fib(n − 1);
        fib(n − 2);
    }
}
```

One useful hyperobject may be a reducer. Code block 7 shows how the collision-detection code may be parallelized using a reducer. The code at line 2 declares ‘output_list’ to be a reducer hyperobject, and line 10 provides one additional level of indirection to access the reducer. In addition to the code shown, the ‘list_reducer’ class may implement a reduce function that can concatenate two lists, as shown in Code Block 8, but the programmer of the collision-detection code may not need to be aware of how this class is implemented. All the programmer may need to do is identify the global variables as reducers when they are declared and provide an additional level of indirection at use points. Alternatively, an embodiment may provide compiler support for automatic dereferencing, so that the programmer may need only to identify the global variables as reducers at the point of declaration, but need make no changes at use points. Alternatively, an embodiment may provide other linguistic specifications at use points. No logic may need to be restructured, and if the programmer fails to catch all the use instances, the compiler may report a type error. Thus, by user annotation of a variable or object in the code as a hyperobject, a hyperpointer, and the like, the hyperobject facility can automatically provide the desired hyperobject semantics. The annotation may indicate that the hyperobject can be reduced.

Code Block 7, a Cilk++ parallelization of the code in Code Block 4 which uses a reducer hyperobject:

```
1  Node *target;
2  hyper_ptr<reducer_list_append<Node *> > output_list;
3  .
      .
      .
4  void walk(Node *x)
5  {
6  switch (x->kind) {
7  case Node::LEAF:
8  if (target->collides_with(x))
9  {
10  (*output_list).push_back(x);
11  }
12  break;
13  case Node::INTERNAL:
14  cilk_for (Node::const_iterator child = x.begin( );
child != x.end( ); ++child)
15  {
16  walk(child);
17  }
18  break;
19  }
20  }
```

Code Block 8, the definition of list reducer used in Code Block 7:

```
template<class T>
class reducer_list_append
{
    std::list<T> value;
    public:
        list_reducer( ) : value( ) { }
        void push_back(const T&element) {
            value.push_back(element);
        }
        void reduce(list_reducer *right) {
            value.splice(value.end( ), right->value);
        }
        const std::list<T> &get_value( ) const {
            return value;
        }
};
```

Another example of a parallelization that uses a reducer is shown in Code Block 9. Conceptually, the reducer hyperobject, which is specified in Code Block 10, may be imagined as being forked into different views at each ‘cilk_spawn’. Each view may be updated so that accumulation may occur in parallel without contention or races. The views may be automatically combined at every ‘cilk_sync’ (or possibly earlier) using the reduce method of the reducer definition in Code Block 10, and so the total accumulated value may be available at the end of the computation. Once again, the programmer of the parallel fib code need not be aware of how the ‘sum_reducer’ class is implemented. Accordingly, the present invention may provide a hyperobject facility for a runtime system that supports a hyperobject including a set of views that may be forked and combined, thereby facilitating parallel accumulation. As in Cilk++, the runtime system may incorporate a work-stealing scheduler. Accordingly, in embodiments, a runtime system may be produced containing a hyperobject facility for allowing code with a nonlocal variable to operate on multiple processors without races, where the hyperobject facility may maintain a set of views that are split and combined, and the runtime system incorporates a work-stealing scheduler. In embodiments, a runtime system may be produced containing a hyperobject facility for allowing code with a nonlocal variable to operate on multiple processors without races, where the hyperobject facility may maintain a set of views that are split and combined, and the runtime system incorporates a work-stealing scheduler.

Code Block 9, a program that computes Fibonacci numbers by accumulating values using a hyperpointer x that points to a reducer of type sum_reducer<int>, whose definition is given in Code Block 10:

```
hyper_ptr< sum_reducer<int> > x;
void fib(int n)
{
    if (n < 2)
        *x += n;
    else {
        cilk_spawn fib(n − 1);
        fib(n − 2);
        cilk_sync;
    }
}
```

Code Block 10, the definition of sum_reducer used in Code Block 9:

```
template<class T>
class sum_reducer<T>
{
    T value;
    public:
        sum_reducer( ) : value( ) { }
        explicit sum_reducer(const T &init) : value(T) { }
        void reduce(sum_reducer<T> *right) {
            value += right->value;
        }
        sum_reducer&operator+=(const T&x) {
            value += x;
            return *this;
        }
        sum_reducer&operator−=(const T&x) {
            value −= x;
            return *this;
        }
        sum_reducer&operator++( ) {
            ++value;
            return *this;
        }
        void operator++(int) {
            ++value;
        }
        sum_reducer&operator−−( ) {
            −−value;
            return *this;
        }
        void operator−−(int) {
            −−value;
        }
        const T&get_value( ) const {
            return value;
        }
}
```

In embodiments, a reducer over a set M with operation and identity e may be a dynamic set of views, where each view may be a C++ object ranging over M. A dynamic set may be a set whose membership changes during the execution of a program. The C++ template syntax hyper_ptr<M> is used to declare a hyperpointer that points to a reducer over M. The set M is intended to be implemented as some C++ type that defines the operation (e.g., by defining an appropriate member function). The identity e may be kept implicitly or a specific value may be used. At any time during the execution of a Cilk++ program, a view may be uniquely “owned” by one strand in the Cilk++ program as described herein. Accordingly, in embodiments, a hyperobject facility may be produced for allowing code with a nonlocal variable to operate on multiple processors without races, where the hyperobject facility may maintain a set of views that are split and combined, and at any given time, each view may be owned by at most one strand of the hyperobject facility. If h is a reducer and T is a strand, we may denote by h_{T} the view of h owned by T. In one embodiment, a hyperpointer may behave syntactically like a pointer to an object of type M, and dereferencing a hyperpointer in a strand may return a reference to the view owned by the strand. If the type of x is hyper_ptr<M>, then the expression *x denotes an object of type M.

When first created, the reducer hyperobject may consist of a single view owned by the strand that creates the hyperpointer, and thus the hyperpointer may behave like an ordinary C++ autopointer (e.g., auto_ptr). When a Cilk directive such as cilk_spawn and cilk_sync is executed, however, the behavior of hyperpointers and C++ autopointers may differ. A cilk_spawn statement may create multiple new Cilk++ strands, such as a child strand that is spawned, and the parent strand that continues after the cilk_spawn statement. Upon a cilk_spawn statement, the child strand may own the view owned by the parent function before the cilk_spawn, the parent strand may own a new view (such as initialized to e), and the like. In an example, let h be a hyperpointer to a reducer x. To reduce the view x_{C} of a completed child strand C into the view x_{P} of a parent strand P, the embodiment may combine the views by setting x_{C}=x_{C} x_{P}, where the symbol “=” denotes the assignment operator, it may destroy the view x_{P}, and the parent strand P may become the new owner of x_{c}. In embodiments, this combining may be implemented by a reduce method. At a cilk_sync in which a parent waits for some children, the views owned by children may be reduced into the view owned by the parent. To preserve the correspondence to a serial program without reducers, the reduce order may be the reverse of the order in which the children were spawned. A reduce method may be applied at other times to combine views, such as at points before the cilk_sync. Moreover, if a view x is combined with the identity view e, the resulting view may be produced as x without applying a reduce method. At a function call, the child may inherit the view owned by the parent, the parent may own nothing while the child is running, and the parent may reown the view when the child returns. The fact that the parent owns no view while the child is running may not cause an error, because the parent performing a function call does not resume execution until the child returns.

In embodiments, the behavior of reducers may have useful properties, such as at any time, at most one strand owns a given view, and thus accesses to reducers through hyperpointers may not require mutual-exclusion mechanisms; object identity of views may be preserved at sync points in the same function; and the like. One embodiment may better ensure that the assertion in the following program holds:

hyper_ptr<T> x;
T *p;
.
.
.
cilk_sync;
p = &(*x);// p points to the view owned by this
strand
/* arbitrary code, including cilk_spawn statements */
cilk_sync;
assert(p == &(*x)); // The view is the same

In embodiments, a reducer may not be just a use-once accumulator, but it may be used for multiple parallel accumulations. For example, one embodiment ensures that the assertion in the following example holds:

```
hyper_ptr<reducer_opadd<int> > x = 0;
void fib(int n)
{
    if (n < 2)
        *x += n;
    else {
        if (n == 25)
            x->set_value(0);
        cilk_spawn fib(n−1);
        fib(n−2);
        cilk_sync;
        if (n == 25)
            assert(x->get_value( ) == 75025); //
fib(25)
    }
}
```

In embodiments, a sum with 0 as identity may be a reducer hyperobject. Also, subtraction may be supported with the same reducer. Sum may be performed over the integers, reals (e.g., floating point), as modular arithmetic, over other algebraic structures such as complex numbers, polynomials, vectors, matrices, and the like. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates accumulating a sum.

In embodiments, a multiply with 1 as identity may be a reducer hyperobject. Also, division may be supported with the same reducer. Multiply may be performed over the integers, reals (e.g., floating point), as modular arithmetic, or over other algebraic structures, such as complex numbers, polynomials, vectors, matrices, and the like. Matrix division may be supported with the same reducer as matrix multiplication, such as matrix inverse and multiply, or the equivalent, such as PLU decomposition or other numerical methods, and the like. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates performing at least one of multiplication and division.

In embodiments, a minimum with ∞ (or MAXINT, etc.) as identity may be a reducer hyperobject, where minimum may be performed over the integers, reals (e.g., floating point), vectors, matrices, an ordered set, and the like. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates calculating a minimum.

In embodiments, a minimum index may be a reducer hyperobject, which reports an index (or identifier) of a minimum value, where minimum may be performed over the integers, reals (e.g., floating point), vectors, matrices, an ordered set, and the like. For example, if an update is performed once per array element, the array index of the smallest element is returned. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates calculating a minimum index.

In embodiments, a maximum with −∞ (or MININT, etc.) as identity may be a reducer hyperobject. Maximum may be performed over the integers, reals (e.g., floating point), vectors, matrices, an ordered set, and the like. Also, maximum index may be a reducer hyperobject. In embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates at least one of calculating a maximum or maximum index.

In embodiments, a logical AND with TRUE (or 1) as identity may be a reducer hyperobject. In addition, a logical AND may be performed on single bits or bitwise, and over arrays, vectors, matrices, and the like. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates calculating a logical AND.

In embodiments, a logical OR with FALSE (or 0) as identity may be a reducer hyperobject. In addition, a logical OR may be performed on single bits or bitwise, and over arrays, vectors, matrices, and the like. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates calculating a logical OR.

In embodiments, a logical exclusive OR (also known as XOR) with FALSE (or 0) as identity may be a reducer hyperobject. In addition, an XOR may be performed on single bits or bitwise, and over arrays, vectors, matrices, and the like. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates calculating a logical XOR.

In embodiments, a logical exclusive NOR (also known as XNOR) with TRUE (or 1) as identity may be a reducer hyperobject. In addition, a logical XNOR may be performed on single bits or bitwise, and over arrays, vectors, matrices, and the like. In embodiments, the present invention may produce a hyperobject facility for allowing code with a nonlocal variable to operate on multiple processors. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates calculating a logical XNOR.

In embodiments, a composition of state machine transitions with the empty transition as identity may be a reducer hyperobject. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates composing state machine transitions.

In embodiments, a string concatenation with the empty string as identity may be a reducer hyperobject. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates concatenating strings.

In embodiments, a parenthesis matcher with the empty string of parentheses as identity may be a reducer hyperobject. For example, each reduce operation of x and y may concatenate x and y, deleting the open parentheses in the suffix of x that match the corresponding closing parentheses in the prefix of y. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates parenthesis matching.

In embodiments, a list append and/or prepend with the empty list as identity may be a reducer hyperobject. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates at least one of a list append operation and a list prepend.

In embodiments, a file or I/O stream concatenation with the empty file or empty stream as identity, respectively, may be a reducer hyperobject. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates at least one of file concatenation and I/O stream concatenation.

In embodiments, a set union operation with the empty set as identity may be a reducer hyperobject. The set may be implemented using a list, hash table, search tree, and the like. Similarly, a set intersection operation with a universal set as identity may be a reducer object. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates performing at least one of a set union operation and a set intersection operation.

In embodiments, a data structure merging, where the data structure is, for example, a hash table, a search tree, a graph, a graph with a property (such as planar), and the like, with the empty data structure as identity may be a reducer hyperobject. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates data structure merging.

In embodiments, a deterministic or nondeterministic merge (selection) of objects with the null object as identity may be a reducer hyperobject. For example, the merge operation may produce one of the two input objects as a result, but never the null object unless both input objects are null. The merging may be randomized, choosing one input position (first or second) over the other with some probability; fair favoring neither input position, unfair, favoring one input position over the other; or the like. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates at least one of deterministic or nondeterministic merging of objects, wherein the merging may be one of randomized, fair, unfair, and the like.

In embodiments, a compound operation on a tuple of objects, where each tuple position can be reduced with its own individual reducing operations and has its own identity may be a reducer hyperobject. For example, (a₁, a₂, a₃) might be reduced with (b₁, b₂, b₃) to produce (a₁+b₁, max {a₂,b₂}, a₃+b₃). Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates a compound operation on a tuple of objects, where each tuple position may be reduced with its own individual reducing operations.

In embodiments, composition of arithmetic carry states, such as generate, propagate, kill, where the elements are drawn from the set {G, P, K} with P as identity, and the like may be reducer hyperobjects, such as in the reduce operation:

$$\begin{matrix} & G & P & K \\ G & G & G & G \\ P & G & P & K \\ K & K & K & K\end{matrix}$$

Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates composition of arithmetic carry states.

In embodiments, segmented operations on ordered pairs (s, x) may be a reducer hyperobject, where is an operation over the set of objects from which x is drawn, e is its identity, and s is a Boolean, such that:

$$( {s}_{1} , {x}_{1} ) ⊗ ( {s}_{2 ,} {x}_{2} ) = \{ \begin{matrix}( {s}_{2} , {x}_{1} ) & if {s}_{2} = TRUE , \\ ( {s}_{1} , {x}_{1} ⊗ {x}_{2} ) & if {s}_{2} = FALSE .\end{matrix}$$

Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates performing segmented operations on ordered pairs.

In embodiments, an operation from an algebraic structure, such a monoid, group, ring, field, and the like, over a set S and identity e belonging to S may be a reducer hyperobject. Accordingly, in embodiments, the present invention may provide a hyperobject facility for allowing code with a nonlocal variable to operate on multiple processors, wherein the hyperobject facility supports a hyperobject including a set of views that may be forked and combined, wherein the hyperobject facilitates an operation from an algebraic structure.

In embodiments, reducers may be implemented in a plurality of ways. For a set M with operation and identity e, one embodiment of the invention implements hyper_ptr<M> as a C++ class with no data members. Objects of this class (hyperpointers) may carry no state, and they may be used only for their memory address. Note that C++ guarantees that two distinct objects have distinct addresses. This embodiment may use the hyperpointer as an index into a hypermap which maps hyperpointers into views. A hypermap may be implemented as any convenient data structure that stores a value indexed by a key, such a hash table, search tree, linked list, and the like. Accordingly, in embodiments, a hyperobject facility may be produced for allowing code with a nonlocal variable to operate on multiple processors without races, where the hyperobject facility may maintain a set of views that are split and combined, and a hypermap may associate hyperobjects with their views. In addition, a hypermap may be implemented using a hash table, search tree, linked list, and the like.

In embodiments, a performance analyzer may be produced in conjunction with a hyperobject facility for allowing code with a nonlocal variable to operate on multiple processors without races, where the hyperobject facility may maintain a set of views that are split and combined, and the performance analyzer may invoke a timer function.

In embodiments, a hyperobject facility may be produced for allowing code with a nonlocal variable to operate on multiple processors without races, where the hyperobject facility may maintain a set of views that are split and combined, and at any time at most one strand of the hyperobject facility may own a given view.

In embodiments, a hyperobject facility may be produced for allowing code with a nonlocal variable to operate on multiple processors without races, where the hyperobject facility may maintain a set of views that are split and combined, and the hyperobject facility may be used for multiple, parallel accumulations.

In embodiments, a hyperobject facility may be produced for allowing code with a nonlocal variable to operated on multiple processors without races, where the hyperobject facility may maintain a set of views that are split and combined, and the code may perform read operations, modify operations, write operations, and the like, on shared variables without requiring atomicity of the operations.

Although the following example employs a hash table, it should be understood that any data structure that associates keys with values could be used. In one embodiment, hypermaps maybe ‘lazy’: when looking up a hyperpointer to a reducer in a hypermap, if the hyperpointer is not present in the hypermap, then the runtime system may interpret the hypermap as containing an identity view of the correct type. Thus, identity values may not be stored (helpful for operation such as min, whose identity may not be convenient to store. Moreover, this property may allow the creation of an ‘empty hypermap’ Ø, defined as a hypermap that maps all reducer hyperpointers into identity views, efficiently.

A reduce of a left hypermap L and a right hypermap R is the operation REDUCE(L, R) defined by setting L(x)=L(x) R(x) for all hyperpointers x, where L(x) denotes the view resulting from the lookup of x in hypermap L, and similarly for R. The left/right distinction may be important, because the operation may not be commutative. If the operation is associative, the result of the computation may be the same as if the program executed serially. The operation REDUCE is destructive: it updates L and destroys R, freeing all memory associated with R. The implementation may maintain hypermaps in full frames only. Dereferences of hyperpointers in stack frames may use the hypermap of the least ancestor full frame, i.e., the full frame at the top of the deque to which the stack frame belongs. For hyperpointer x, the syntax *x searches the hypermap using x as a key. Alternative syntaxes may be used to dereference the hyperpointer. For example, the syntaxes x ( ), x (with automatic dereferencing), x.hyper, and the like may be used to dereference the hyperpointer in alternative embodiments. Accordingly, in embodiments, a hyperobject facility may be produced for allowing code with a nonlocal variable to operate on multiple processors without races using the same linguistic specification for accessing the hyperobject that would be used for accessing a variable or object in a serial processing system, where the hyperobject facility may maintain a set of views that are split and combined.

To allow for lock-free access to the hypermap of a full frame while siblings and children of the frame are terminating, which may provide benefits such as reduced contention, simplicity of implementation, and the like, each full frame may store multiple (e.g., in this example, three) hypermaps, such as denoted by HYPER_PTR, RIGHT, and CHILDREN. The HYPER_PTR map may be the only one used for lookup of views in the user's program. The other two hypermaps may be used for bookkeeping purposes. Informally, the CHILDREN hypermap may contain the accumulated value of completed children frames, but these reducers have not yet been reduced into the parent's HYPER_PTR hypermap, because the parent is currently running. The RIGHT hypermap may contain the accumulated value of right siblings of the current frame that have terminated. (A “right” sibling of a frame may be one that comes after the frame in the sequential order, and its values may therefore be on the right-hand side of the operator.) If the operator is commutative, we may reduce the RIGHT hypermap of a frame with the CHILDREN hypermap of the parent frame, but in general the RIGHT hypermap may be stored separately to reduce hyperpointers in a proper order without assuming commutativity.

In embodiments, when the top-level full frame is initially created, all three hypermaps may be initially empty. The hypermaps may be updated in a number of situations, such as upon a lookup failure, upon a steal, upon a return from a call, upon a return from a spawn, at a cilk_sync, and the like.

A lookup failure may insert an implicit identity element into the hypermap, as described herein. Accordingly, in embodiments, a hyperobject facility may be produced for allowing code with a nonlocal variable to operate on multiple processors without races, where the hyperobject facility may maintain a set of views that may be split and combined, and upon a lookup failure, an implicit identity element may be inserted into a hypermap.

A steal operation steals a parent frame P and creates a new child frame C, where the hypermaps are updated, such as by setting HYPER_PTR_{C}=HYPER_PTR_{P}, HYPER_PTR_{P}=Ø, CHILDREN_{C}=Ø, RIGHT_{C}=Ø, and the like. These updates are consistent with the intended semantics of hyperpointers, in which the child owns the view and the parent owns a new identity view. Accordingly, in embodiments, a hyperobject facility may be produced for allowing code with a nonlocal variable to operate on multiple processors without races, where the hyperobject facility may maintain a set of views that may be split and combined, and upon a spawn operation, a view may be at least one of created and transferred.

In a return from a call, for example, let frame C be a child of parent frame P which originally called C, and suppose that C returns. Then, update HYPER_PTR_{P}=HYPER_PTR_{C}, which transfers ownership of child views to the parent. The other two hypermaps of C may be guaranteed to be empty and do not participate in the update. Accordingly, in embodiments, a hyperobject facility may be produced for allowing code with a nonlocal variable to operate on multiple processors without races, where the hyperobject facility may maintain a set of views that may be split and combined, and upon a return from a call, a view may be transferred.

In a return from a spawn, for example, let frame C be a child of parent frame P which originally spawned C, and suppose that C returns. Then, update HYPER_PTR_{C}=REDUCE(HYPER_PTR_{C}, RIGHT_{C}), where completed right-sibling frames of C are reduced into the hyperpointers of C. Then, depending on whether has a left sibling or not, there may be subcases, such as if C has a left sibling L, update RIGHT_{L}=REDUCE (RIGHT_{L}, HYPER_PTR_{C}), accumulating into the RIGHT hypermap of L; if C is the leftmost child of P, update CHILDREN_{P}=REDUCE(CHILDREN_{P}, HYPER_PTR_{C}), storing the accumulated values of C into the parent, since there is no left sibling to reduce with; and the like. Accordingly, in embodiments, a hyperobject facility may be produced for allowing code with a nonlocal variable to operate on multiple processors without races, where the hyperobject facility may maintain a set of views that may be split and combined, and upon a return from a spawn, two or more views may be combined.

A cilk_sync statement may wait until all children have completed. After frame P passes the cilk_sync statement but before executing any client code, update HYPER_PTR_{P}=REDUCE(CHILDREN_{P}, HYPER_PTR_{P}), reducing hyperobjects of completed children into the parent. Accordingly, in embodiments, a hyperobject facility may be produced for allowing code with a nonlocal variable to operate on multiple processors without races, where the hyperobject facility may maintain a set of views that may be split and combined, and a upon a sync, two or more views may be combined.

In embodiments, the present invention may provide for optimizations, such as in relation to global variables, compiler, dynamic caching of lookup, loop variables, and the like. When a hyperpointer refers to a global variable, the associative lookup may be avoided, because there may be only one global variable with a given name. In one embodiment, for a P-processor execution, a static global array of size P, indexed by processor number, may store the values of the hyperpointer. An alternative is to allocate a hyperpointer to a fixed location in worker-local storage. Dereferencing the hyperpointer accesses the worker's copy. Accordingly, in embodiments, a compiler may be produced in conjunction with a hyperobject facility for allowing code with a nonlocal variable to operate on multiple processors without races, where the hyperobject facility may maintain a set of views that are split and combined, and the hyperobject facility employs a lookup, a lookup in worker-local storage, and the like.

In relation to compiler optimization, the semantics of hyperpointers may help ensure that *x returns the same view in any fragment of code that does not contain parallel control constructs, such as cilk_spawn or cilk_sync statements or across iterations of a cilk_for loop. In embodiments, the fragment may contain function calls. In these situations, the compiler may emit code to perform the associative lookup, such as only once per fragment. This optimization may be similar to the common subexpression elimination optimization routinely employed by compilers. Accordingly, in embodiments, a compiler may be produced in conjunction with a hyperobject facility for allowing code with a nonlocal variable to operate on multiple processors without races, where the hyperobject facility may maintain a set of views that are split and combined, and the compiler may emit code to avoid multiple associative lookups for fragments of code that contain no parallel control constructs.

With respect to dynamic caching of lookup, as an alternative to or in addition to compiler optimizations, the result of an associative lookup may be cached in the reducer object itself. In this optimization, each reducer object may store an array A of P pointers to views, where P is the maximum number of workers in the system. All such pointers may be initially NULL. When executing the dereference operation *x, worker w may first read the pointer x. A[w]. If the pointer is not NULL, then the worker may use the pointer to access the view. Otherwise, the worker may look up x in the appropriate hypermap and may dynamically cache the result of the lookup into x. A[w]. When the hypermap of a worker changes, e.g., because the worker steals a different frame, the pointers cached by that worker may be invalidated. Accordingly, in embodiments, a compiler may be produced in conjunction with a hyperobject facility for allowing code with a nonlocal variable to operate on multiple processors without races, where the hyperobject facility may maintain a set of views that are split and combined, and the hyperobject facility employs dynamic caching of lookup.

With respect to loop variables, when a loop contains several hyperpointers allocated at the same level of nesting outside the loop, the compiler may aggregate the hyperpointers into a single data structure, and only one associative look-up may be done for the entire data structure, rather than one for each hyperpointer. This scheme works, because the knowledge of how the compiler packs the hyperpointers into the fields of the data structure outside the loop may be visible to the compiler when processing dereferences inside the loop. Accordingly, in embodiments, a compiler may be produced in conjunction with a hyperobject facility for allowing code with a nonlocal variable to operate on multiple processors without races, where the hyperobject facility may maintain a set of views that are split and combined, and the hyperobject facility employs one lookup for a set of variables.

In embodiments, the present invention may provide compiler support for automatic dereferencing of hyperobjects. As specified in Code Block 11, the variable x is specified as a hyper_object rather than a hyper_ptr. The compiler may treat hyper_object as new keyword, and record the type of x in the symbol table as a hyperobject proxy for a sum_reducer. Implementing compiler support for proxies is well known to persons of ordinary skill in the art. For subsequent uses of the variable x in the program, the compiler may insert code to dereference the hyperobject. An alternative embodiment may define hyper_object as an instance of a more general facility for declaring proxies. Another alternative embodiment, shown in Code Block 12, may define hyper_object as a special kind of class having a different view in each strand of execution. A variety of alternative syntaxes may be supported in like fashion. Accordingly, in embodiments, a compiler may be produced in conjunction with a hyperobject facility for allowing code with a nonlocal variable to operate on multiple processors without races, where the hyperobject facility may maintain a set of views that are split and combined, and the hyperobject facility employs compiler support for automatic dereferencing.

Code Block 11: An alternative declaration and use of hyperobjects with automatic dereferencing:

```
hyper_object< sum_reducer<int> > x;
void fib(int n)
{
    if (n < 2)
        x += n; /* No need to dereference */
    else {
        cilk_spawn fib(n − 1);
        fib(n − 2);
        cilk_sync;
    }
}
```

Code Block 12: An alternative method for defining hyperobjects:

template <class T>
hyper_object class sum_reducer
{
/* Same class body as in Code Block 10 */
};
sum_reducer<int> sum; /* sum is a hyperobject. */

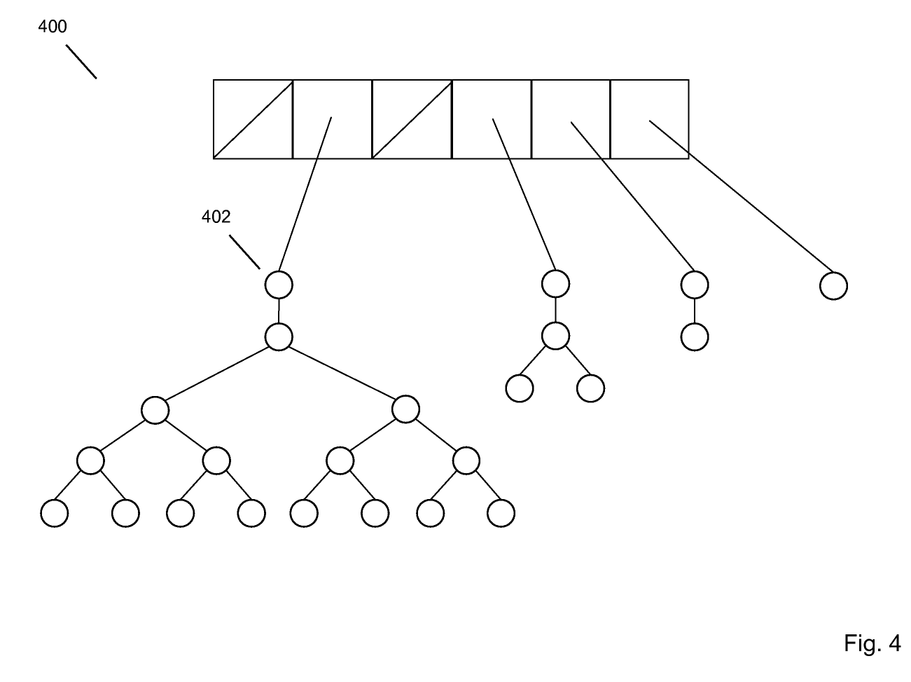

In embodiments, the present invention may provide an implementation of a bag data structure 400, such as shown in FIG. 4, where a bag with 23 elements 402 is illustrated. Some applications may need an implementation of an unordered dynamic set. The present invention may provide for an efficient library implementation of an unordered set called a “bag.” Declaring the bag as a reducer admits an efficient parallel implementation, and may be related to a pennant. A pennant may be a tree where the root has only one child consisting of a complete binary tree on 2^{k} elements for some integer k. Two pennants A and B both of size 2^{k} may be unioned to form a pennant of size 2^{k+1}, such as to modify the root of A so that its second child is the child of B, modify the root of B so that its only child is the root of A, the root of the pennant is the root of B, and the like. A bag may be a collection of pennants, each of a different size. A bag may be represented by an array, list, or other data structure with pointers to the pennants it contains. In embodiments, the implementation of a bag may use an array where the kth component of the array contains either a null pointer or a pointer to a pennant of size 2^{k}. In this instance, a pennant xₖ of size 2^{k} may be added to a bag S, such as if S[k]=NULL, set S[k]=xₖ and terminate; if S[k]=yₖ, where yₖ is a pennant of size 2^{k}, union xₖ and yₖ to form a pennant xₖ₊₁ of size 2^{k+1}, set S[k]=NULL, and recursively add xₖ₊₁ to S; and the like. Note that this process may be like a binary increment of a counter.

In an example, given three pennants x, y, and z, where each is either of size 2^{k} or is empty, we may reduce them to produce a pair of pennants (s, c)=f (x, y, z), where s has size 2^{k} or is empty and c is of size 2^{k+1} or is empty. The following table details an embodiment of the process by which f is computed, where 0 means that the pennant is empty and 1 means that it has size 2^{k}:

| x | y | z | s | c |
|---|---|---|---|---|
| 0 | 0 | 0 | NULL | NULL |
| 1 | 0 | 0 | x | NULL |
| 0 | 1 | 0 | y | NULL |
| 0 | 0 | 1 | z | NULL |
| 1 | 1 | 0 | NULL | UNION(x, y) |
| 1 | 0 | 1 | NULL | UNION(x, z) |
| 0 | 1 | 1 | NULL | UNION(y, z) |
| 1 | 1 | 1 | x | UNION(y, z) |

This process may be used to reduce two bags A and B using an auxiliary variable y which holds a pennant, such as y=NULL; for k=0 to n do (A[k], y)=f (A [k], B [k], y), and the like. In embodiments, all elements of a bag S may be visited in parallel using code such as:

```
void walk(pennant *x) {
    if (x) use(x);
    cilk_spawn walk(x->left); walk(x->right);
    cilk_sync;
}
void visit(bag *S) {
    cilk_for (int k=0; k<S->top( ); ++k)
    {
        walk(S[k]);
    }
cilk_sync;
}
```

In embodiments, there may be a plurality of applications for reducers, such as linear algebra, games, spreadsheets, word processing, physical modeling, defense, underwater, sorting, data compression, multimedia, searching, graphics rendering, biology, chemistry, medicine, financial, banking, speech, photography, graphics, operating systems, printing, user interfaces, music, shipping, social networking, artificial intelligence, programming-language implementation, hashing, satellite images of agriculture, transportation sensors, embedded systems, encryption, machine learning, machine vision, networking, aerospace, and the like.

In embodiments, reducers may be applied in relation to a mathematics application, such as a linear algebra application. For instance, a linear algebra application may perform a matrix-vector multiplication, declaring each element of an output vector to be a hyperobject, and reduce with addition. A next step may be to process the matrix by columns in parallel. For example, the jth element of column i may be multiplied by ith component of the input vector and accumulated into the jth component of the output vector. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a mathematics application.

In embodiments, reducers may be applied in relation to computer entertainment, such as computer games. For instance, a game program may contain a serial loop over entities, such as monsters, characters, landscape features, and the like, forming a list of entities that are close enough to the player's character to interact. To make the iterations of the serial loop operate in parallel, the list may be declared to be a reducer, such as reducing with append. Accordingly, the present invention may provide a runtime system for a multiple processing computing system including multiple strands, associating with the runtime system a hyperobject facility that may maintain a dynamic set of views. The hyperobject facility may implement a hyperobject by managing operations on the views, and may include creation, accessing, modifying, transferring, forking, combining, destruction, and the like. In embodiments, the computer code operating on the runtime system may implement a computer entertainment application.

In embodiments, reducers may be applied in relation to data forms, such as spreadsheets. For instance, a formula in a spreadsheet may indicate the sum of many cells. For example, in Excel, the formula=sum (A1:A1100) in cell B1 indicates that the sum of the contents of cells A1, A2, . . . , A100 should be displayed in cell B1. In this case, the value in cell B1 may be declared to be a reducer, such as reducing with ordinary addition, allowing the sum to be computed in parallel. Accordingly, the present invention may provides a runtime system for a multiple processing computing system including multiple strands, associating with the runtime system a hyperobject facility that may maintain a dynamic set of views. In embodiments, the hyperobject facility may implement a hyperobject by managing operations on the views, including, accessing, modifying, transferring, forking, combining, destruction, and the like. In embodiments, the computer code operating on the runtime system may implement a spreadsheet application.

In embodiments, reducers may be applied in relation to a word processing application. For instance, the application may find all occurrences of a word in a document and produce a list of all such matches. In this instance, the output list may be declared to be a reducer, such as reducing with append. A next step may be to partition the document into pieces that may be processed separately, and the matches starting in each piece may be appended to the output list. Accordingly, the present invention may provide a runtime system for a multiple processing computing system including multiple strands, and associating with the runtime system a hyperobject facility that may maintain a dynamic set of views. The hyperobject facility may implement a hyperobject by managing operations on the views, including accessing, modifying, transferring, forking, combining, destruction, and the like. In embodiments, the computer code operating on the runtime system may implement a word processing application.

In embodiments, reducers may be applied in relation to modeling application, such as a physical modeling application. For instance, given two complex physical objects in space, the application may produce a bag of all of their including parts that intersect. A next step may be to declare the output bag to be a reducer, and reducing with the union operation on bags. A further step may be to process all the parts of one object in parallel, and for each part, compare it to all the parts of the second object. In this instance, whenever two parts collide, the application may add the pair to the bag. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including accessing, modifying, transferring, forking, combining, destruction, and the like. In embodiments, the computer code operating on the runtime system may implement a modeling application.

In embodiments, reducers may be applied in relation to defense applications. For instance, reducers may be applied to underwater sonar applications, where the submarine's environment may produce a set of entities, and one wishes to know for each entity whether it is a threat. In this instance, the application may declare a list as a reducer, such as reduce with append, check all the entities in parallel to determine whether they are threats, adding the threats to the list, and the like. In embodiments, the present invention may take an application for processing a point cloud of data, and provide a hyperobject facility for enabling operation of the point cloud processing application in a parallel processing environment. The point cloud may be a sonar data, radar data, raster image data, laser scanner data, and the like. Accordingly, the present invention may provide a runtime system for a multiple processing computing system including multiple strands, and associating with the runtime system with a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a defense application.

In embodiments, reducers may be applied in relation to sorting. For instance, the application may partition the items to be sorted into groups such that the ith group contains elements that are all larger than the elements, such as in the (i−1)st group. A next step may be to sort each group independently in parallel, concatenating the output lists using a list reducer. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including accessing, modifying, transferring, forking, combining, destruction, and the like. In embodiments, the computer code operating on the runtime system may implement a sorting application.

In embodiments, reducers may be applied in relation to applications such as data compression and multimedia. For instance, the application may declare an output file to be a reducer, such as reducing with file concatenation. The application may then compress an input data file or audiovisual stream by breaking it into pieces, compressing each piece independently in parallel, and then writing the results to the output file. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including, accessing, modifying, transferring, forking, combining, destruction, and the like. In embodiments, the computer code operating on the runtime system may implement a data compression application, a multimedia application, and the like.

In embodiments, reducers may be applied in relation to searching applications. For instance, the applications may return a list of documents that contain a given word pattern, and declare the output list to be a reducer, such as reducing with append, and process all documents in parallel. In this instance, whenever the word pattern occurs in the document, the document may be added to the list. In embodiments, the present invention may take code for a search application, and provide a hyperobject facility for enabling operation of the search application in a parallel processing environment. Accordingly, the present invention may provide a runtime system for a multiple processing computing system including multiple strands, and associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a searching application.

In embodiments, reducers may be applied in relation to graphics applications. For instance, the first step in a radiosity calculation may be to compute the amount of light each surface receives from the various light sources. In this instance, the application may declare the light intensity on each surface as a reducer, such as reducing with floating-point addition. For each light source in parallel, the application may update the appropriate surface intensities. In embodiments, the present invention may take a computer code for rendering graphics capable of operating on a single processor and capable of representing light on a modeled surface from a modeled light source, and provide a hyperobject facility for enabling code to operate on multiple processors. As another example, in 3-dimensional rendering, the application may declare each output pixel to be a reducer, reducing with minimum and storing a corresponding color value. In this instance the application may render each polygon surface in the input as a set of pixels, each with a distance from the viewer and a color. Placing each pixel into the output may cause the color of the pixel closest to the viewer to be visible and the further away pixels hidden. Accordingly, the present invention may provide a runtime system for a multiple processing computing system including multiple strands, associating with the runtime system a hyperobject facility that maintains a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a graphics application.

In embodiments, reducers may be applied in relation to the sciences, such as biology, chemistry, physics, medicine, and the like. For example, in drug synthesis, given two biochemical molecules, the application may search over all relative positions to find the one with least potential energy. In this instance, the application may declare the (position, potential energy, etc.) as a reducer, such as reducing with min-index on the second coordinate. In embodiments, the present invention may, in a computer model including molecular states for instance, provide a hyperobject facility for allowing the model to operate on multiple processors. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a science related application.

In embodiments, reducers may be applied in relation to financial applications. For instance, a financial application may provide for portfolio optimization, such as calculating an expected return based on starting conditions and probability of loss/gain per asset. In this instance, the application may sum the returns of each asset using a reducer, such as reducing with sum, and divide by the total number of assets at the end of the computation. In embodiments, the present invention may optimize a portfolio of financial assets. For instance, computer code may be taken for calculating an expected return based on an initial condition and a probability of a gain or loss for an asset. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a financial application.

In embodiments, reducers may be applied in relation to banking applications. For instance, given a set of debits and credits to an account, the application may compute the balance. In this instance, the application may declare each account to be a reducer, such as reducing with addition. For all the debits and credits in parallel, the application may add the credits and the negative of the debits to the appropriate account. In embodiments, the present invention may provide for tracking transactions, such as by taking computer code for tracking an order for a security, where the code may be designed to run on a single processor, and providing a hyperobject facility for allowing the computer code to operate on multiple processors. Accordingly, the present invention may provide a runtime system for a multiple processing computing system including multiple strands, associating with the runtime system a hyperobject facility that maintains a dynamic set of views. In embodiments, the hyperobject facility may implement a hyperobject by managing operations on the views, including creation, accessing, modifying, transferring, forking, combining, destruction, and the like. In embodiments, the computer code operating on the runtime system implements a banking application.

In embodiments, reducers may be applied in relation to speech processing. For instance, maximum-likelihood estimators used in speech recognition may compute the shortest path in a graph by repeatedly decreasing the tentative distance of some nodes from the origin based on the tentative distance of their neighbors from the origin. In this instance, the application may maintain a reducer for each node, such as reduce with minimum. The application may visit all the nodes in parallel repeatedly, and if the computed distance to a neighbor from the origin is smaller than the current tentative distance, update the neighbor with the smaller value. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a speech processing application.

In embodiments, reducers may be applied in relation to photography. For instance, the application may rescale the image intensities of pixels in an image based on the overall minimum and maximum intensities in the image. In this instance, the application may declare the minimum min and maximum max intensities to be reducers, reducing with minimum and maximum operators, respectively. The application may visit all the pixels in parallel, and update min and max. Then, the application may visit all the pixels again and rescale the intensity of each pixel, such as according to the formula x′=x/(max−min), where x is the original intensity of the pixel and x′ is the rescaled intensity. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a photography application.

In embodiments, reducers may be applied in relation to operating systems. For instance, in a file system, the application may declare a file to be a reducer, such as reducing with file concatenation. In this instance, the application may write the file in parallel, which may result in an output file equivalent to one produced by a serial execution. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement an operating system application.

In embodiments, reducers may be applied in relation to printing and user interfaces. For instance, current document formats (e.g., Postscript, PDF) may render a document on a raster device, such as a printer or a display as part of a user interface, and rely on the fact that raster commands issued later in the document overwrite the pixels modified by earlier commands. To render these formats in parallel, the application may maintain a hyperpointer for each pixel or suitable group of pixels, and the ‘reduce’ of two elements LEFT and RIGHT is RIGHT. Further, to implement α-blending, the application may reduce with (1−α) LEFT+αRIGHT. Accordingly, the present invention may provide a runtime system for a multiple processing computing system including multiple strands, associating with the runtime system a hyperobject facility that maintains a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a printing application, a user interface application, and the like.

In embodiments, reducers may be applied in relation to music. For instance, a musical score may have several voices, instruments, and the like. In an example, the music from several voices may be transcribed by declaring each measure to be a list declared as a reducer, such as reducing with list append. Each voice then may add its notes to the list. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a music application.

In embodiments, reducers may be applied in relation to shopping and social networking. For instance, in an online shopping website, collaborative filtering may be a strategy for recommending other products to buy based on the history of a user's purchases and those of others who bought similar items. Item-based collaborative filtering may proceed in an item-centric manner, such as building an item-item matrix determining relationships between pairs of items, using the matrix, and the data on the current user, infer their taste, and the like. One strategy for determining the preference for a user may be to sum the weighted contributions from multiple sources. The application may declare the preferences of users to be reducers, such as reducing with sum. Then, the other users may be processed in parallel, adding in their weighted contributions based on the item-item matrix. A similar strategy may be used for matching partners in a social network. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a shopping application, a social networking application, and the like.

In embodiments, reducers may be applied in relation to artificial intelligence. For instance, many AI algorithms may depend on combining contributions from multiple heuristic rules to determine a probabilistic course of action. The application may use reducers to sum the contributions and weights of multiple rules. Accordingly, the present invention may provide a runtime system for a multiple processing computing system including multiple strands, associating with the runtime system a hyperobject facility that maintains a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement an artificial intelligence application.

In embodiments, reducers may be applied in relation to programming-language implementation. For instance, when a statement block contains a cilk_spawn or other parallel control construct and the block may be reentered, for example, because it is the body of a loop, the variables defined within the block may cause inadvertent races unless they are interpreted as being recreated each time through the block. Moreover, when a program counter leaves a block, the variables allocated within the block may not be deallocated (and in C++, their destructors run), until all spawns within the block have completed. This “lexical scoping” of variables may be supported by the Cilk++ runtime system using reducers. For instance, a variable address may be defined to be a reducer, where two special address values are distinguished. For example, and without loss of generality, let's call them 0 (the identity) and DONE. In this instance, an address x reduces with an address y using the following table:

| | y | | |
|---|---|---|---|
| x | normal | 0 | DONE |
| normal | y | x | DONE |
| 0 | y | 0 | DONE |
| DONE | DONE | DONE | DONE |

In embodiments, the Cilk++ runtime system may perform operations on a variable x, such as declaration, allocating fresh storage for the variable, and setting the reducer to this storage; variable reference, using the variable in the storage allocated at the declaration; end of scope, looking up the pointer in the hypermap, and if the result is normal, running the destructor on the result, and setting the reducer to DONE; reducing of x and y, applying the reducing operator and calling x's destructor unless x is the result of the reduce; and the like. Accordingly, the present invention may provide a runtime system for a multiple processing computing system including multiple strands. In embodiments, the runtime system a hyperobject facility may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a programming language application.

In embodiments, reducers may be applied in relation to hashing. For instance, some hash functions may be ‘composable’ in the sense that the hash signature of a large file may be computed from the signature of file parts using an associative reducing function. To compute the signature for a large file, the application may declare the signature to be a reducer, such as using the associative reducing function, and process the file pieces in parallel, automatically reducing the signatures. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a hashing application.

In embodiments, reducers may be applied in relation to remote sensing applications, such as satellite images of agriculture. For instance, satellite images of Earth can be inspected to identify the type of agricultural terrain in the image. It may be desirable to classify the images based on the type of terrain. In this instance, a list or bag of each type of terrain may be declared as a list reducer. The application may visit all the images in parallel, determine the type of terrain, and add the image to the appropriate list or bag, and the like. Accordingly, the present invention provides a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a remote sensing application.

In embodiments, reducers may be applied in relation to transportation, sensors, and embedded systems. For instance, in an automobile, sensors may gather information about different parts of the car, such as for the engine, heating/cooling, headlights, brakes, exhaust, tires, and the like, and each sensor may report whether a problem arises with its corresponding part. To determine whether a problem exists anywhere, the application may declare a Boolean variable to be a reducer, such as reducing with logical OR. Further, processing the sensor outputs in parallel, each may OR its error condition into the Boolean value, resulting in a TRUE value if and only if any of the sensors reports an error. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a transportation application, a sensor application, an embedded application, and the like.

In embodiments, reducers may be applied in relation to cryptography. For instance, block encryption of a file may be performed in parallel by breaking the file into its blocks and encrypting each piece independently. To assemble the various outputs as a single file, the application may declare the output file to be a reducer, such as reducing with file concatenation, and the encrypted blocks may be written to the file in parallel. Decryption may be performed in parallel similarly. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a cryptography application.

In embodiments, reducers may be applied in relation to machine learning and machine vision. For instance, a neural network may classify visual images using a supervised machine-learning strategy such as back-propagation. This process may begin with a sample input and iteratively updates it using a series of steps. One such step may be to compute the output of the neural network based on the current input. Each neuron may compute a weighted sum of the outputs from other neurons or the network input. In this instance, the application may declare each neuron to be a reducer, such as reducing with sum. Further, the application may process the neurons in parallel, multiplying the output of each neuron by the given weight and adding the result to the connecting neurons whose inputs are connected to the output of the given neuron. Accordingly, the present invention may provide a runtime system for a multiple processing computing system including multiple strands, associating with the runtime system a hyperobject facility that may maintain a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement at a machine learning application, a machine vision application, and the like.

In embodiments, reducers may be applied in relation to networking. For instance, messages in a computer network may be checked for errors by XOR'ing the words in the message together and comparing the result with a checksum transmitted with the message. In this instance, the application may declare the computed value to be a reducer, such as reducing with bitwise XOR. Further, the application may process words of the message in parallel, such as XOR'ing each word into the computed value. At the end, the application may compare the computed value to the checksum. Accordingly, the present invention may provide a runtime system for a multiple processing computing system including multiple strands, associating with the runtime system a hyperobject facility that may maintains a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement a networking application.

In embodiments, reducers may be applied in relation to aerospace. For instance, in an inertial-guidance system, measurements of acceleration may be taken, such as equally spaced in time, and by integrating them, velocity can be determined. In this instance, the application may declare the velocity to be a reducer, such as reducing with floating-point sum. The application may parallel process the set of acceleration measurements, adding each acceleration value into the sum. The result is the final velocity. Accordingly, the present invention may provide a runtime system for a multiple processing computing system including multiple strands, associating with the runtime system a hyperobject facility that maintains a dynamic set of views. In embodiments, the hyperobject facility may implement a hyperobject by managing operations on the views, including creation, accessing, modifying, transferring, forking, combining, destruction, and the like. In embodiments, the computer code operating on the runtime system may implement an aerospace application.

Another type of useful hyperobject may be a splitter. Consider the Example code in Code Block 13, and walks a binary tree and computes the maximum depth max_depth of any leaf in the tree. The code maintains a global variable depth indicating the depth of the current node. It increments depth in line 15 before recursively visiting the children of a node and decrements depth in line 18 after visiting the children. Whenever the depth of a leaf exceeds the maximum depth seen so far, stored in another global variable max_depth, line 11 updates the maximum depth. Although this code makes use of a global variable to store the depth when it could be passed as an argument, code may contain this kind of usage pattern, sometimes with a push/pop on a stack instead of an increment/decrement of an integer, a modification/restoration of a complex data structure, or other operation paired with an inverse-like type of operation, and the like.

Code Block 13, a C++ program that determines the maximum depth of a node in a binary tree using global variables:

```
1  int depth(0);
2  int max_depth(0);
3  .
    .
    .
4  void walk(Node *x)
5  {
6  switch (x->kind)
7  {
8  case Node::LEAF:
9  max_depth = std::max(depth, max_depth);
13  break;
14  case Node::INTERNAL:
15  ++depth;
16  walk (x->left);
17  walk(x->right);
18  −−depth;
19  break;
20  }
21  }
```

Parallelizing this code seems at first straightforward, where spawning may be provided at each of the recursive walk routines in lines 16-17. The max_depth variable can be made a reducer with maximum. The depth variable may be problematic, however. If nothing is done, then a data race may occur, because the two spawned subcomputations will both try to increment depth in parallel. Moreover, as these subcomputations themselves recursively spawn, many more races may occur. It is advantageous for each of the two spawned computations to treat the global variable depth as if it were a local variable, so that each subcomputation can modify its own view without interference. A splitter hyperobject may provide this functionality. Code block 14 shows how the code from Code Block 13 may be parallelized by specifying the global variable depth to be a splitter hyperpointer. The annotation may indicate that the hyperobject can be split. Code block 15 defines the reducer and splitter classes used in Code block 14.

Code Block 13, a C++ program that determines the maximum depth of a node in a binary tree using global variables:

```
1  int depth(0);
2  int max_depth(0);
3  .
    .
    .
4  void walk(Node *x)
5  {
6  switch (x->kind)
7  {
8  case Node::LEAF:
9  max_depth = std::max(depth, max_depth);
13  break;
14  case Node::INTERNAL:
15  ++depth;
16  walk (x->left);
17  walk(x->right);
18  −−depth;
19  break;
20  }
21  }
```

Code Block 14, a Cilk++ program that determines the maximum depth of a node in a binary tree using a reducer and a splitter:

```
1  hyper_ptr < sum_splitter<int> > depth;
2  hyper_ptr < max_reducer<int> > max_depth;
3  .
    .
    .
4  void walk_s(Node *x)
5  {
6  switch (x->kind)
7  {
8  case Node::LEAF:
9  max_depth->max_of(*depth);
13  break;
14  case Node::INTERNAL:
15  ++(*depth);
16  cilk_spawn walk_s(x->left);
17  walk_s(x->right);
18  sync;
19  −−(*depth);
20  break;
21  }
22  }
```

Code Block 15, the definition of max_reducer and sum splitter used in Code Block 14:

```
template<class T>
class max_reducer<T>
{
    bool has_value;
    T value;
    // Not copyiable
    max_reducer(const max_reducer&);
    max_reducer& operator=(const max_reducer&);
    public:
        max_reducer( ) : has_value(false) { }
        max_reducer(T &init) : has_value(true), value(init) { }
        void reduce (max_reducer *right) {
            if (right->has_value)
                this->max_of(right->value);
        }
        void max_of(const T&other) {
            if ( !has_value || other > value) {
                value = other;
                has_value = true;
            }
        }
        const T& getValue( ) const { return value;}
};
template<class T>
class sum_splitter<T>
{
    T value;
    public:
        typedef sum_splitter splitter_data;
        sum_splitter(const T &init) : value(T) { };
        sum_splitter(on_split_t,
                const sum_splitter&leftMost,
                const splitter_data&split)
            : value(split.value) { }
        void reduce(sum_splitter *right) { /* no-op */ }
        sum_splitter&operator++( ) {
            ++value;
            return *this;
        }
        sum_splitter&operator−−( ) {
            −−value;
            return *this;
        }
        const T& getValue( ) const { return value;}
        operator const T&( ) const { return value;}
}
```

To be precise about the semantics of splitters, a cilk_spawn statement may create multiple new Cilk++ strands, such as the child strand that is spawned, and the parent strand that continues after the cilk_spawn, and the like. Upon a cilk_spawn the child strand may own the view C owned by the parent function before the cilk_spawn; the parent strand may own a new view C′, initialized nondeterministically to either the value of C before the cilk_spawn or the value of C after the child returns from the cilk_spawn; and the like. Notice that in Code Block 13, the value of the depth is the same before and after each call to walk in lines 16-17. Thus, for the corresponding parallel code, the nondeterministic second condition above may be deterministic, because the values of depth before and after a cilk_spawn are identical. Commonly, a splitter may obey the consistency condition that, when executed serially, the value of the splitter exhibits no net change from immediately before a spawn to immediately after the spawn. That is, the spawned subcomputation may change the value of the splitter during its execution, but it must restore the splitter's value one way or another before it returns.

In embodiments, the present invention may provide implementation of splitters. In an example, the managing of managing splitter hyperobjects will be described. The basic idea is to keep a hypertree of hypermaps. Dereferencing a hyperpointer x may involve a search from the hypermap associated with the executing frame up the hypertree until the value is found. The two basic operations on a splitter hypermap may include HYPERMAP-INSERT (h, x, v), inserting the key-value pair (x, v) into the hypermap h; HYPERMAP-FIND (h, x), looking up the hyperpointer x in the hypermap h and returning the value stored in h that is associated with x, or return NULL if the value is not found, where if h=NULL (the hypermap does not exist), signal an error; and the like.

The runtime data structures described herein may be extended to support splitters. Recall that each worker may have a spawn deque implemented as an array, where each index i may store a call stack. The top and bottom of the deque may be indexed by worker-local variables H and T, where array position i may contain a valid pointer for H≦i<T. Each deque location may be augmented to store a pointer deque[i].h to a hypermap. Each worker worker also maintains an active hypermap worker.h. The hypermap may be implemented as any convenient data structure that stores a value indexed by a key, such using a hash table, search tree, linked list, and the like. The remainder of this example employs a hash table, but it should be understood that any data structure that associates keys with values could be used. In addition, a parent h.parent pointer may be stored with each hypermap h, which may point to the parent hypermap in the hypertree (or NULL for the root of the hypertree). Each hypermap h may have multiple (e.g., two) children, such as identified as h.spawn and h.cont. The runtime system may execute certain operations at distinguished points in the client program, such as when the user program dereferences a splitter hyperobject, upon a cilk_spawn, upon return from a cilk_spawn, upon a random steal, and the like. In a general case, these actions may all be intended to be executed as if they were atomic.

In one embodiment, a lock stored with the worker data structure may be used to enforce atomicity. In another embodiment, separate locks may be stored in the data structure. In yet another embodiment, atomicity may be maintained using nonblocking protocols. Any of these embodiments involves ways of enforcing atomicity that would be generally understood by a person of ordinary skill in the art.

In embodiments, the present invention may dereference a hyperpointer to a splitter. For instance, dereferencing a hyperpointer x to a splitter in a worker w may be accomplished by executing SPLITTER-LOOKUP (w.h, x), where the SPLITTER-LOOKUP(h, x) function is implemented by pseudocode such as hiter=h, while (v=HYPERMAP-FIND (hiter,x))==NULL, set hiter=hiter parent, if h≠hiter, then HYPERMAP-INSERT (h, x, v), and the like. In embodiments, a plurality of optimizations may be provided for the following example optimizations, such as for hypermaps in the deque, rather than following parent pointers in the search up the hypertree, the auxiliary pointers in hypermaps can be omitted and the search can walk up the deque itself; after looking up a value in an ancestor hypermap, all intermediate hypermaps between the active hypermap and the hypermap where the value was found can be populated with the key-value pair; and the like.

In embodiments, an optimization may be related to cilk_spawn. For instance, let w be the worker that executes cilk_spawn. Set parent=w.h, and create child as a fresh empty hypermap, set parent.spawn=child, set parent.cont=NULL, set child.parent-parent, push parent onto the bottom of w's deque, set w.h=child, and the like.

In embodiments, an optimization may be related to a return from a cilk_spawn. For instance, let w be the worker that executes the return statement. Let child=w.h, and let parent=child.parent. In this instance, there may be two cases to consider. One if the deque is nonempty, such as for all keys x that are both in child and parent, update the value in parent to be the value in child, destroy child, and set w.h=parent. The other if the deque is empty, such as destroy child, for all keys x that are in parent but not inparent.cont, insert the parent value into parent cont. Then set w.h=parent.cont., spliceparent out the hypertree, and destroyparent. In either case, control may resume according to the ‘return from cilk_spawn’ description described herein.

In embodiments, an optimization may be related to a random steal. Recall that on a random steal, the thief worker thief removes the topmost call stack from the victim victim's deque victim.deque of the victim. For instance, let bootyh be the youngest hypermap on victim's deque, create a fresh empty hypermap h, set h.parent=bootyh, set bootyh.cont=h, set thief.h=h, and the like.

In embodiments, an optimization may be related to extensions and optimizations. The described embodiment may perform a copy-on-access, but one may also do copy-on-write. A reference-counting wrapper may convert copy-on-access to copy-on-write. In one embodiment, an empty hypermap may be represented by a null pointer. In one embodiment, the hypermaps for splitters and reducers may be combined, rather than keeping separate data structures for each. In one embodiment, when a cilk_spawn causes a stack frame to be allocated, the hypermaps in the deque may be initialized to NULL to indicate that no hypermaps are yet associated with the deque entry. In another embodiment, these pointers may be left uninitialized and flags are maintained elsewhere in the data structure to specify whether the pointers are valid. This latter embodiment may allow the flags to be initialized simultaneously with other flags as a single word operation when the stack frame is allocated, thereby minimizing overhead when splitters are not used.

In embodiments, reducers and splitters may fit into a general framework in which hyperobjects may conceptually be forked and joined at cilk_spawn and cilk_sync operations. The present invention may support the forking through associative lookup in some map, perhaps a hash table plus some caching. For general hyperobjects, at a cilk_spawn the child always receives the original view. As for the parent, there may be different cases, such as copy, identity, and the like, where copy is when a parent receives a copy of the view, and identity is when the parent receives a view with an identity value. The joining of views may happen at any strand boundary before the cilk_sync. In this instance, there may be multiple cases, such as reduce, ignore, and the like, where reduce is the child view discarded, and where the parent view gets the view of the child, and ignore is the parent view discarded, and the parent receives the view of the child. For example, consider the pattern (identity, ignore), where this pattern may be a generalization of thread-local storage. Associated pseudo code may be:

```
T global_variable;
void proc1( ) {
    for (i = 0; i < N; ++i) {
        global_variable = f(i);
        proc2( ) ;
    }
}
void proc2( ) { proc3 ( ) ; }
void proc3( ) { proc4 ( ) ; }
void proc4( ) {
use(global_variable);
}
```

In this fragment, global_variable may be used as a mechanism to pass values from proc1 to proc4 without passing spurious parameters to proc2 and proc3. The for loop cannot be replaced with a parallel cilk_for loop because of the resulting race conditions on global_variable. Races are avoided, however, if global_variable is declared to be a hyperobject. This technique avoids the need to restructure proc2 and proc3 to be aware of the values passed from proc1 to proc4. Note that patterns (identity, reduce) and (copy, ignore) correspond to descriptions described herein. Consider pattern (copy, reduce). This pattern may be used to compute the span of the computation as described herein, where an algorithm for computing the span based on two state variables is described, called span and cspan. That span may act like a splitter, whereas cspan may act like a reducer over the associative operation max. Because the two variables are updated based on each other's values, the pair of variables may be viewed as a general hyperobject that requires both COPY and REDUCE actions.

In embodiments, the present invention may provide tools that may help a serial programmer write faster and more correct parallel programs, referred here as p-tools. These p-tools may be used for a plurality of tasks, including detect race conditions in a multithreaded program, analyze and predict application performance, and the like. Software p-tools that address these fundamental parallelism issues may improve the productivity of programmers developing multithreaded applications on multicore processors. These p-tools may leverage the programmer's skills to write fast, correct serial programs and may provide an automated path to add concurrency to that serial program while potentially avoiding common parallel-programming problems. In embodiments, the present invention may provide a debugging tool that reports races in computer code in a multiple processing environment, include a performance analysis tool that reports a measure on the execution of computer code in a multiple processing environment, and the like, where the measure may include work, span, parallelism, spawns, syncs, calls, parallel granularity, serial granularity, lock contention, false sharing, and the like.

In one embodiment, the p-tools may be built using binary-instrumentation technology. These tools may make it comparatively easy to examine a binary executable and either rewrite it to perform instrumentation at runtime or intercept instructions dynamically during runtime execution and perform instrumentation dynamically. A person of ordinary skill in the art would understand how instrumentation can be added to an existing binary executable using these tools. Accordingly, in embodiments, a debugging tool may be produced in conjunction with a hyperobject facility for allowing code with a nonlocal variable to operate on multiple processors without races, where the hyperobject facility may maintain a set of views that are split and combined, and the debugging tool may employ binary instrumentation. In another embodiment, the p-tools may be built using compiler technology, where the compiler may be directed to insert the instrumentation code into the program code, rather than operating on the binary as with the previous embodiment. Accordingly, in embodiments, a debugging tool may be produced in conjunction with a hyperobject facility for allowing code with a nonlocal variable to operate on multiple processors without races, where the hyperobject facility may maintain a set of views that are split and combined, and the debugging tool employs instrumentation inserted into the code by a compiler.

In one embodiment, the p-tools may be based on enhancing the binary executable format to provide metadata relevant to multithreaded execution. The Cilk++ compiler (or any compiler for a multithreaded language) may cause this metadata to be embedded in the executable in a multithreaded executable format (MEF) as part of the ordinary compilation process. In one embodiment, the p-tools may operate directly on the optimized MEF binary distributed to end users, rather than on a “debug” version, thereby ensuring accuracy and confidence in the p-tool results.

The MEF binary may include metadata to inform the p-tools of where Cilk++'s control constructs (e.g., function call, cilk_spawn, cilk_sync, return, cilk_for, mutex operations, etc.) “occur.” In particular, statements involving these keywords may be translated into sequences of instructions that include in-lined calls to the Cilk++ runtime system. The p-tools may then instrument the user code while avoiding instrumentation of the instructions belonging to the runtime system itself. The metadata provided in the MEF binary may allow the p-tools to disambiguate the user code from runtime code easily without elaborate pattern matching in the binary.

In one embodiment, the MEF may be defined using standard executable formats, such as ELF for Linux, the COFF format for Windows, and the like. These formats may provide the ability for compilers to write their own metadata in “private” sections. The Cilk++ compiler may insert directives into the object code or into metadata to annotate specific instructions of the final output, such as the precise instruction at which a cilk_spawn or a cilk_sync is considered to occur, thereby producing an instrumented binary executable. For example, in one embodiment an instrumentation preprocessor may insert an explicit label at a given control point in the source code by means of an asm directive, such as

asm volatile(“CILK_LABEL_L1: # nop”).
This directive may label the current instruction with a name of a known form. By creating a table of such labels in a designated private section of the MEF, the p-tools may later find the needed information. In another embodiment, the compiler may insert equivalent directives directly during compilation. Accordingly, in embodiments, a debugging tool may be produced in conjunction with a hyperobject facility for allowing code with a nonlocal variable to operate on multiple processors without races, where the hyperobject facility may maintain a set of views that are split and combined, and the debugging tool may use metadata to identify the location of synchronizing events in the code.

In embodiments, there may be p-tools associated with race detection. A data race may exist in a program execution if two logically parallel strands access the same location, the strands hold no locks in common, and at least one of the strands writes to the location. For example, in Code Block 1, suppose that line 18 is replaced with qsort (max (begin+1, middle−1), end). The resulting serial code is still correct (albeit with a minor performance bug), but the parallel code now contains a race bug, because the two subproblems overlap, which could cause an error during execution. Race bugs are pernicious, because they occur nondeterministically. A program with a race bug may execute successfully billions of times during testing, only to raise its head after the application is shipped. Even after detecting a race bug, writing regression tests to ensure its continued absence is difficult. One aspect of the invention may be a race detector that understands hyperobjects.

In a single serial execution on a test input for a deterministic program, race bug algorithms may help ensure that a race bug is reported if the race bug is exposed: that is, two different schedulings of the parallel code would produce different results. The strategy employed by the algorithms is to use efficient data structures to track the series-parallel relationships between strands during a serial execution of the parallel code, and then instrument every load and store to discover races. The Cilk++ race detector may use the metadata in the MEF binaries to identify the location of synchronizing events precisely and track the series-parallel relationships between Cilk strands. The race detector may then intercept every relevant load and store and determine whether a race has occurred. The Cilk++ race detector may report races involving hyperobjects properly. Because it may understand the MEF binary, it may know which memory references involve hyperobjects and may thereby avoid reporting races.

In one embodiment, the Cilk++ race detector may instrument each hyperobject lookup operation, and may mark the result of the lookup operation as fresh memory that is never subject to race conditions. If the result of the lookup involves a data type with deep structure, such using a tree, list, hash table, or other data structure involving pointers or indices, the race detector may mark the entire deep structure as fresh memory.

In another embodiment, the Cilk++ race detector may simulate the runtime hypermaps described herein to behave as if the runtime system had stolen the parent frame of each cilk_spawn operation and promoted it to full frame, independently of whether the runtime system actually effected such a promotion. In this embodiment, the Cilk++ race detector may associate one or more hypermaps with each stack frame, and instrument the execution so as to mimic the actions executed by the runtime system on full frames for the corresponding hypermap. For example, for reducer hypermaps, the Cilk++ race detector may execute actions, such as to associate with each stack frame multiple hypermaps; whenever function P spawns or calls function C, proceed as in the “steal” case; at a return from a spawn, return from a call, or sync operation; at a lookup operation performed by frame A, use the hypermap HYPER_PTR_{A} for the lookup. Note that this may be different from the uninstrumented execution, where the runtime system may use the hypermap stored in the nearest full frame instead of the hypermap stored in the current stack frame. In a serial implementation of this embodiment, the RIGHT hypermap may be always empty and it may be eliminated from the implementation. The Cilk++ race detector or other p-tool may also detect that a hyperobject is being used improperly. For example, suppose that a reducer is supposed to implement associative operations on integers. If one strand updates the reducer hyperobject using += and another uses *=, an inconsistent result may occur. By storing the updating operator in its shadow space, these conflicts may be flagged and reported such as on an update of location l in strand s using operator=, where if shadow operator is not compatible with “=”, report error, Otherwise, set shadow operator=“=”, and continue with normal race detection, and the like. The “compatibility” in the above code may be determined by membership in a table of compatible operator pairs. For example, += and −= on integers might be compatible, because updating an integer by adding a value to it and then subtracting a second value from it could always be done in either order and yield the same result. The operations += and *=, however, would not be compatible.

In embodiments, rather than or in addition to simulating the runtime hypermaps, the Cilk++ race detector may instruct the runtime system to behave as follows. When the runtime system performs a hyperobject lookup, a spawn, a call, a return from a spawn, a return from a call, a sync, executes user code, and the like, then the runtime system may promote zero or more stack frames on a worker's spawn deque into full frames. This promotion may have the same effect as a sequence of zero or more steal operations performed on the spawn deque, except that the frames stolen may not be executed immediately, but may instead be suspended. This behavior may allow the race detector to find races in the code implementing the hyperobject itself.

Another aspect of the present invention may be a performance analyzer p-tool which provides measures on the runtime performance of a Cilk++ program. The Cilk++ approach may admit a performance model for a computation based on a directed acyclic graph, or dag, where vertices are strands and a directed edge (u, v) connects two strands u and v if u precedes v in that U must complete execution before v can begin. A vertex in this dag may become ready when all its predecessors have been executed.

In embodiments, performance measures, such as “work” or “span” described herein, may provide a practical way of gauging the theoretical efficiency of a parallel program, such as a Cilk++ program. Let Tp denote the execution time of a particular computation on P processors. The work T₁ may be the theoretical execution time on a single processor. The span T_{∞} may be the theoretical execution time on an infinite number of processors, which corresponds to the length of the longest path in the dag. Consider a theoretical model for parallel-program execution where scheduling overhead is negligible and strands always take the same time to execute no matter what the scheduling context. Although this theoretical model ignores some realities, it can provide good performance estimates in practice. For example, in this model, the running time of any program satisfies two inequalities: T_{P}≧T_{∞}, where a P-processor computer can do no more work in one step than an infinite-processor computer; and T_{P}>T₁/P, where in one step, a P-processor computer can do at most P work. The speedup of a computation on P processors is the ratio T₁/T_{P}, which indicates how many times faster the P-processor execution is than a one-processor execution. If T₁/T_{P}≈P, then we say that the P-processor execution exhibits linear speedup. The maximum possible speedup in the model is T₁/T_{∞}, which is also called the parallelism of the computation, because it represents the average amount of work that can be done in parallel for each step along the path that realizes the span.

Computing the work of a deterministic computation may include running the program on a single processor and measuring its running time. Measuring the span by a similar method would require an infinite number of processors, however. Fortunately, the span may be computed by taking timing measurements of the strands as the program executes and computing the longest path in the dag. Then, the parallelism may be computed by taking the ratio of work to span. This single number, the parallelism of the computation, lets a programmer estimate the maximum of processors on which an application will run efficiently. The measures of work and span may provide a good understanding of the parallelism of an application, allowing programmers to direct their attention to the key bottlenecks in their code. Other measures of interest may include various measures of granularity, which help to measure overheads.

The performance analyzer may calculate these measures for a given application, as well as other measures. The metadata in the MEF binary necessary to compute these values may be the same or similar to those for the race detector, or the Cilk++ runtime system may calculate these values directly. The p-tool may identify when the running program calls a function, spawns, syncs, returns, throws an exception, enters the runtime system, and the like. It may then make timer calls to a high-precision timer time function, such as the QueryThreadCycleTime function in the Windows Vista operating system, to measure the running times of the various strands. The running time of a strand executing in a frame A may be measured by storing the value of the time function when the strand begins executing and subtracting this value from the time function when the strand ends its execution. The execution time of the last strand executed in a frame A may be stored in a frame variable length[A].

In an example, one embodiment may compute the measures as follows. For each frame A, maintain frame variables span[A], cspan[A], work[A], calls[A], spawns[A], and syncs[A]. For the frame ROOT that starts the computation, initialize span[ROOT]=0, cspan[ROOT]=−∞, work[ROOT]=0, calls[ROOT]=0, spawns[ROOT]=0, and syncs[ROOT]=0. Whenever we end the execution of a strand in a frame A, we may first set span[A]+=length[A], and work[A]+=length[A], before taking any of the following possible actions. When a frame B is called by a frame A, we set span[B]=span[A], cspan[B]=−∞, work[B]=0, calls[A]+=1, spawns[B]=0, and syncs[B]=0. Whenever a called frame B returns to its parent A, we may update span[A]=span [B], work[A]+=work[B], calls[A]+=calls[B], and spawns[A]+=spawns[B], and syncs[A]+=syncs[B]. When a frame B is spawned by a frame A, we may set span[B]=span[A], cspan[B]=−∞, work[B]=0, spawns [A]+=1, calls[B]=0, spawns[B]=0, and syncs[B]=0. When a spawned frame B returns to its parent A, we may update cspan[A]=max {cspan[A], span[B]}, work[A]+=work[B], calls[A]+=calls[B], spawns[A]+=spawns[B], and syncs[A]+=syncs[B]. Whenever a frame A executes a cilk_sync, we may set span[A]=max {span[A], cspan[A]}, cspan[A]=−∞, and syncs[A]+=1. Other actions of the runtime system, such as handling an exception, may be similarly handled. For the case of exceptions, for example, the exception may be treated as a series of “abnormal” returns up through the stack to the point where the exception is caught, and execute the same operations at each abnormal return as for an ordinary return. At the end of the computation, the value of work[ROOT] may provide a measure of the work of the computation, and the value of span[ROOT] may provide a measure of the span of the computation.

In embodiments, the performance analyzer may account for Cilk++ programs that use hyperobjects. The performance analyzer may store work and span information in hypermaps in addition to storing it in frames. For instance, whenever a hypermap H is created, let span [H]=−∞ and work[H]=0. When a frame B returns to its parent A, B may or may not yield a hypermap that is later merged with another hypermap. For example, in embodiments of reducer hyperobjects that maintain three hypermaps per full frame but no hypermaps per stack frame, then B may yield a hypermap if B is a full frame. If B does not yield a hypermap, update cspan[A]=max {cspan[A], span[B]}, work[A]+=work[B], as in the embodiment without hyperobjects. If B yields a hypermap H, set span[H]=span[B] and work[H]=work[B]. Whenever two hypermaps H₁ and H₂ are merged to produce hypermap H, let t be the time for the reduce operation. Set span[H]=t+max {span[H₁], span[H₂]}, work[H]=t+work[H₁]+work[H₂]. Before frame A executes a cilk_sync instruction, if A is associated with hypermap H, set span[H]=span[A]. After frame A has completed a cilk_sync instruction, if A is associated with hypermap H, set span[A]=max {span[A], cspan[A], span[H]}, work[A]+=work[H]. Then, set work[H]=0. Other measures, such as call, spawns, syncs, and the like, may be computed similarly.

In another embodiment, the work may be computed by simply timing the execution of the serial program. Parallelism may be calculated as work[ROOT]/span[ROOT]. The parallel granularity of the computation is work[ROOT]/(2×spawns[ROOT]+syncs[ROOT]+1), which may help diagnose how much parallel linkage overhead is in the computation. For example, in Cilk++ on a modern x86 processor, a spawn/return may cost about 4 times the cost of an ordinary function call/return and about 450 times faster than a WinAPI CreateThread/ExitThread. Despite this low overhead, if a programmer spawns indiscriminately, the application may suffer the full slowdown of 4 compared to a C++ serial execution, rather than the 1-2% typically seen. If the programmer knows that the parallel granularity is small compared to spawn/return time, he or she can take steps to coarsen subcomputations being spawned. Likewise, the serial granularity of the computation is work[ROOT]/(calls[ROOT]+spawns[ROOT]+1), which may help diagnose how much function call linkage overhead is in the computation. Other measures of granularity may also be computed in a similar fashion. In another embodiment, counting the number of calls, spawns, and syncs may be done by keeping global variables which are incremented whenever the appropriate action occurs. Many other strategies yield equivalent results in an equivalent fashion, such as calculating the number of spawns by counting the number of associated returns from spawns.

In embodiments, the performance analyzer may provide an accurate measure of lock contention and may analyze which locks have the potential to bottleneck the computation as the processors scale up. This measure of contention may be a function of the computation, not just of the way a particular execution was scheduled. To understand the basis of the performance analyzer's method for analyzing lock contention, consider a dag G=(V, E) and a lock l. Let i,j V be two nodes in the dag. We say that i contends with j on lock l if they both hold the lock and i∥j (i operates logically in parallel with j). Define the contention of i and j on l to be:

$${C}_{i} ( i , j ) = \{ \begin{matrix}1 \\ 0\end{matrix} \begin{matrix}if i contends with j , \\ otherwise ;\end{matrix}$$

And the overall contention on lock l to be

$${c}_{i} = {\sum }_{i ∈ V} {\sum }_{j ∈ V} {C}_{i} ( i , j ) .$$

For series-parallel dags, lock contention may be computed on the fly during a serial (or parallel) execution. An abstract description of this computation may first be provided, and then given a concrete implementation in the context of Cilk++. Abstractly, for each lock l, we may associate a pair of measures (Cₗ(A), Wₗ(A)) (the contention record) with each subdag A of the computation. The value Cₗ(A) is the contention on l due to nodes in A, and Wₗ(A) is an auxiliary measure that counts the number of nodes in A that execute while holding lock l. The contention record may be computed by structural induction on a series-parallel dag. For a base case, a dag A consisting of a single node v, there is Cₗ(A)=0 (a node does not contend with itself), and Wᵢ(A)=1 if v holds l, and Wᵢ(A)=0 otherwise. For a serial composition, a dag D consisting of the serial composition of two dags A and B, compute Wₗ(D)=Wₗ(A)+Wₗ(B), and Cₗ(D)=Cₗ(A)+Cₗ(B). Parallel composition, a dag D consisting of the parallel composition of two dags A and B, compute Wₗ(D)=Wₗ(A)+Wₗ(B), and Cₗ(D)=Cₗ(A)+Cₗ(B)+Wₗ(A)−Wₗ(B).

In embodiments, this description may refer to the case of a program with a single lock. If the program has more than one lock, a map that associates lock l with its contention record may be maintained. The map may be updated by updating each element of the map independently of the others. An embodiment of calculating lock contention in the context of the Cilk++ language will now be described, which may express series-parallel dags by means of the cilk_spawn and cilk_sync keywords. For simplicity, the algorithm is described for the case where the program has only a single lock, but it is understood that the general case may be handled by using maps, instead of scalar variables, and the program may include hyperobjects.

In embodiments, with each function instance, a number of quantities may be associated, such as a contention record R, a contention record E, a stack S of contention records, and the like. For example, to compute the lock contention, the program may be executed as usual, and in addition may perform a number of actions, such as function entry, spawn, sync, return, and the like. Further, the function entry may be at the beginning of each function, set R=E=(0, 0), set the stack S to be empty, and the like. At a cilk_spawn, E may be pushed onto the stack S, and the stack entry may be marked as serial. A next step may include execution of the child function, which may return a contention record F. Then F may be pushed onto S and this stack entry may be marked as parallel. Finally, E may be set, such as E=(0, 0). At a return, R may be updated to the “serial composition” of R and E, and the contention record R may be returned to the caller. Other instructions may also be provided. When executing an instruction other than cilk_spawn, cilk_sync, or return, a temporary contention record T may be built using the “base case” of a single-node dag that may execute the instruction, and E may be set to the “serial composition” of E and T.

Other kinds of contention, including false sharing, may be analyzed using a similar method. False sharing may occur when two independent variables lie on the same cache line and each is accessed by a different processor. Because hardware maintains consistency on a cache-line basis, the cache line may bounce between the two processors. One of the reasons false sharing may be pernicious is that for most language systems, it may not easily be diagnosed in the source code. Specifically, the programmer sometimes may not control which variables the compiler chooses to locate on the same cache line. Moreover, inserting diagnostic logic into the source code may mask false sharing, because the compiler may now locate the conflicting variables on different cache lines. Once false sharing is discovered, however, it may sometimes be solved by padding the variables to ensure that the compiler places them on different cache lines.

As with lock contention, the performance analyzer's method for analyzing false sharing may consider a dag G=(V, E) and a cache line m. For example, let i,j V be two nodes. We say that i and j share line m if both access m (load or store), at least one of them stores, and i∥j. Similar to lock contention, an overall sharing on line m may be defined, and compute line-sharing on the fly using essentially the same algorithm as for lock contention.

In embodiments, a runtime system may be provided for a multiple processing computing system including multiple strands, and associating with the runtime system a hyperobject facility that may maintain a dynamic set of views of a hyperobject. The hyperobject facility may manage operations on the views, including creation, accessing, modifying, transferring, forking, combining, destruction, and the like. The hyperobject may be a reducer, a splitter, and the like. In addition, the runtime system may incorporate a work-stealing scheduler.

In embodiments, a runtime system may be provided for a multiple processing computer system including multiple strands, and associating with the runtime system a facility that may enable the operation of a plurality of views of a linguistic object in the multiple processing computer system. Access to the object may be specified independently from the linguistic control constructs of the code operating on the runtime system. Operation may maintain the identity of the object, so that any updating of the object may result in updating of a view. The linguistic object may be a hyperobject, such as a splitter, a reducer, and the like. In addition, the runtime system may incorporate a work-stealing scheduler.

In embodiments, a runtime system may be provided for a multiple processing computer system including multiple strands, and associating with the runtime system a hyperobject facility that may maintain a dynamic set of views of a hyperobject. The hyperobject facility may enable code running on the runtime system to operate in the multiple processing computer system using the same linguistic specification for accessing the hyperobject as would be used for accessing a variable or object in a serial processing system. The hyperobject may be a reducer, a splitter, and the like. In addition, the runtime system may incorporate a work-stealing scheduler.

In embodiments, a runtime system may be provided for a multiple processing computer system including multiple strands, defining an object that may act as if it automatically forks and combines, thereby facilitating the operation of code running on the runtime system to operate in the multiple processing computer system. The object may be associated with a hyperobject, such as a reducer, a splitter, and the like. In addition, the runtime system may incorporate a work-stealing scheduler.

In embodiments, a runtime system may be provided for running computer code, where a hyperobject facility may enable code to operate in a multiple processing system using the same linguistic specification for accessing a hyperobject as would be used for accessing a variable or object in a serial processing system. The hyperobject may be linguistically designated by an annotation in the code, where the hyperobject may be a reducer, a splitter, and the like. In addition, the runtime system may incorporate a work-stealing scheduler.

In embodiments, a runtime system may be provided for running computer code, where a hyperobject facility may enable code to operate in a multiple processing system. The hyperobject facility may operate on a variable or object in the code which is annotated to indicate that it may be reduced, split, and the like. The code may use the same linguistic specification for accessing the variable or object as would be used for accessing a variable or object in a serial processing system. The code may use the same linguistic specification for accessing the variable or object as would be used for accessing a variable or object in a serial processing system with one or more additional levels of indirection.

In embodiments, a compiler may be provided that enables the operation of computer code in a multiple processing system, wherein the computer code may contain a linguistic specification of a hyperobject, where the hyperobject may be a reducer, a splitter, and the like.

In embodiments, a hyperobject may be provided that enables the operation of computer code in a multiple processing system. The hyperobject may implement a set, and the set may be implemented as a data structure, the set may be an unordered set, the set may be an unordered set such as a bag data structure, and the like. The hyperobject may be a reducer, where the reducer may implement the unioning of sets, the intersection of sets, and the like.

In embodiments, a debugging tool may be provided for computer code in a multiple processing system, where the computer code may contain a linguistic specification of a hyperobject. The debugging tool may report races in the computer code. The race may not include logically parallel compatible accesses to the hyperobject. The debugging tool may report incompatible operations on the hyperobject, where the hyperobject may be a reducer, a splitter, and the like.

In embodiments, a performance analysis tool may be provided that reports a measure on the execution of computer code in a multiple processing system, where the computer code may contain a linguistic specification of a hyperobject. The measure may include work, span, parallelism, spawns, syncs, calls, parallel granularity, serial granularity, lock contention, false sharing, and the like. The hyperobject may be a reducer, a splitter, and the like.

The elements depicted in flow charts and block diagrams throughout the figures imply logical boundaries between the elements. According to software or hardware engineering practices, however, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++ or Java, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A programming method, comprising:
providing a runtime system for a multiple processing computing system including multiple strands; and
associating with the runtime system a hyperobject facility that maintains a dynamic set of views of a hyperobject.

2. The method of claim 1, wherein the hyperobject facility manages operations on the views, including one or more of creation, accessing, modifying, transferring, forking, combining, and destruction.

3. The method of claim 1, wherein the hyperobject is a reducer.

4. The method of claim 1, wherein the hyperobject is a splitter.

5. The method of claim 1, wherein the runtime system incorporates a work-stealing scheduler.

6. A programming method, comprising:
providing a runtime system for a multiple processing computer system including multiple strands; and
associating with the runtime system a facility that enables the operation of a plurality of views of a linguistic object in the multiple processing computer system.

7. The method of claim 6, wherein access to the object is specified independently from the linguistic control constructs of the code operating on the runtime system.

8. The method of claim 6, wherein operation maintains the identity of the object, so that any updating of the object results in updating of a view.

9. The method of claim 6, wherein the linguistic object is a hyperobject.

10. The method of claim 9, wherein the hyperobject is a splitter.

11. The method of claim 9, wherein the hyperobject is a reducer.

12. The method of claim 6, wherein the runtime system incorporates a work-stealing scheduler.

13. A programming method, comprising:
providing a runtime system for a multiple processing computer system including multiple strands; and
associating with the runtime system a hyperobject facility that maintains a dynamic set of views of a hyperobject.

14. The method of claim 13, wherein the hyperobject facility enables code running on the runtime system to operate in the multiple processing computer system using the same linguistic specification for accessing the hyperobject as would be used for accessing a variable or object in a serial processing system.

15. The method of claim 13, wherein the hyperobject is a reducer.

16. The method of claim 13, wherein the hyperobject is a splitter.

17. The method of claim 13, wherein the runtime system incorporates a work-stealing scheduler.

18. A programming method, comprising:
providing a runtime system for a multiple processing computer system including multiple strands; and
defining an object that acts as if it automatically forks and combines, thereby facilitating the operation of code running on the runtime system to operate in the multiple processing computer system.

19. The method of claim 18, wherein the object is associated with a hyperobject.

20. The method of claim 19, wherein the hyperobject is a reducer.

21. The method of claim 19, wherein the hyperobject is a splitter.

22. The method of claim 18, wherein the runtime system incorporates a work-stealing scheduler.

23. A programming method, comprising:
providing a runtime system for running computer code; and
providing a hyperobject facility for enabling code to operate in a multiple processing system using the same linguistic specification for accessing a hyperobject as would be used for accessing a variable or object in a serial processing system.

24. The method of claim 23, wherein the hyperobject is linguistically designated by an annotation in the code.

25. The method of claim 23, wherein the hyperobject is a reducer.

26. The method of claim 23, wherein the hyperobject is a splitter.

27. The method of claim 23, wherein the runtime system incorporates a work-stealing scheduler.

28. A programming method, comprising:
providing a runtime system for running computer code; and
providing a hyperobject facility for enabling code to operate in a multiple processing system.

29. The method of claim 28, wherein the hyperobject facility operates on a variable or object in the code which is annotated to indicate that it can be at least one of reduced and split.

30. The method of claim 28, wherein the code uses the same linguistic specification for accessing the variable or object as would be used for accessing a variable or object in a serial processing system.

31. The method of claim 28, wherein the code uses the same linguistic specification for accessing the variable or object as would be used for accessing a variable or object in a serial processing system with one or more additional levels of indirection.

32. A programming method, comprising:
providing a compiler that enables the operation of computer code in a multiple processing system, wherein the computer code contains a linguistic specification of a hyperobject.

33. The method of claim 32, wherein the hyperobject is a reducer.

34. The method of claim 32, wherein the hyperobject is a splitter.

35. A programming method, comprising:
providing a hyperobject that enables the operation of computer code in a multiple processing system.

36. The method of claim 35, wherein the hyperobject implements a set.

37. The method of claim 36, wherein the set is implemented as a data structure.

38. The method of claim 36, wherein the set is an unordered set.

39. The method of claim 38, wherein the unordered set is a bag data structure.

40. The method of claim 35, wherein the hyperobject is a reducer.

41. The method of claim 40, wherein the reducer implements the unioning of sets.

42. The method of claim 40, wherein the reducer implements the intersection of sets.

43. A programming method, comprising:
providing a debugging tool for computer code in a multiple processing system,
wherein the computer code contains a linguistic specification of a hyperobject.

44. The method of claim 43, wherein the debugging tool reports races in the computer code.

45. The method of claim 44, wherein a race does not include logically parallel compatible accesses to the hyperobject.

46. The method of claim 43, wherein the debugging tool reports incompatible operations on the hyperobject.

47. The method of claim 43, wherein the hyperobject is a reducer.

48. The method of claim 43, wherein the hyperobject is a splitter.

49. A programming method, comprising:
a performance analysis tool that reports a measure on the execution of computer code in a multiple processing system, wherein the computer code contains a linguistic specification of a hyperobject.

50. The method of claim 49, wherein the measure is at least one of work, span, parallelism, spawns, syncs, calls, parallel granularity, serial granularity, lock contention, and false sharing.

51. The method of claim 49, wherein the hyperobject is a reducer.

52. The method of claim 49, wherein the hyperobject is a splitter.
